(19) United States
(12) Patent Application Publication
(10) Pub. No.: US 2019/0369613 A1
(43) Pub. Date: Dec. 5, 2019

(54) ELECTRONIC DEVICE AND METHOD FOR CONTROLLING MULTIPLE DRONES

(71) Applicant: Samsung Electronics Co., Ltd., Suwon-si, Gyeonggi-do (KR)

(72) Inventors: Choon-Kyoung MOON, Suwon-si (KR); Su-Hyun NA, Seoul (KR); Tae-Ho WANG, Seoul (KR); Eun-Kyung YOO, Seoul (KR); Olivia LEE, Seoul (KR); Jong-Kee LEE, Seoul (KR); Hee-Young CHUNG, Seongnam-si (KR); Byoung-Uk YOON, Hwaseong-si (KR); Chang-Ryong HEO, Suwon-si (KR)

(21) Appl. No.: 16/472,787

(22) PCT Filed: Dec. 26, 2017
(86) PCT No.: PCT/KR2017/015486

§ 371 Date: Jun. 21, 2019

(30) Foreign Application Priority Data
Dec. 23, 2016 (KR) 10-2016-0178306

(51) Int. Cl. G05D 1/00; G05D 1/10; G06F 3/0481; B64C 39/02

(52) U.S. Cl. CPC G05D 1/0022; G05D 1/0027; G05D 1/101; B64C 2201/146; B64C 39/024; B64C 2201/12; G06F 3/04815

(57) ABSTRACT

Various embodiments of the present invention provide a drone comprising a communication module for wirelessly communicating with an external drone, and a processor configured to: when the distance from the external drone is greater than or equal to a first distance and is less than a second distance, control the position of the drone by using GPS information of the external drone, received through the communication module, and a sensor included in the drone; and when the distance from the external drone is greater than or equal to the second distance, control the position of the drone by using the GPS information.

### CROSS-REFERENCE TO RELATED APPLICATIONS

This application is a National Phase Entry of PCT International Application No. PCT/KR2017/015486, which was filed on Dec. 26, 2017, and claims priority to Korean Patent Applications No. 10-2016-0178306, which was filed in the Korean Intellectual Property Office on filed on Dec. 23, 2016, the entire disclosure of each of these applications is incorporated herein by reference.

### BACKGROUND

### 1. Field

The disclosure relates to an electronic device controlling multiple drones and a method for controlling the same.

### 2. Description of Related Art

As electronic devices have been rapidly developing nowadays, various tasks can be conducted with drones controlled through electronic devices. When control is performed, a pairing process for connecting a drone and an electronic device is performed. Once paired, the drone can perform a predetermined task such as photographing sought by a user controlling the location and capabilities of the drone.

By means of the electronic device during a task, the user can not only control a single drone but also connect multiple drones and allow the multiple drones to perform the task simultaneously or sequentially. When a task has been performed by multiple drones, the electronic device can collect respective results recorded by the multiple drones performing the task and can generate a single piece of content or integrated information.

### SUMMARY

When multiple drones are controlled by an electronic device, a collision can occur between the multiple drones while multiple drone control methods are being employed.

An electronic device and control method according to various embodiments of the disclosure can provide a method for operating drones on the basis of information related to the drones.

The electronic device according to various embodiments of the disclosure may include a communication module and a processor configured to: control a first drone and a second drone among multiple drones by using a sensor included in the second drone and GPS information, received through the communication module, of the first drone and the second drone, when the distance between the first drone and the second drone is greater than or equal to a first distance and is smaller than a second distance; and control the first drone and the second drone by using the GPS information, when the distance between the first drone and the second drone is greater than or equal to the second distance.

In a non-transitory computer-readable recording medium in which a program to be executed in a computer is recorded, according to various embodiments of the disclosure, the program may cause, when executed by a processor, the processor to perform the operations of: controlling a first drone and a second drone among multiple drones by using a sensor included in the second drone and GPS information, received through the communication module, of the first drone and the second drone, when the distance between the first drone and the second drone is greater than or equal to a first distance and is smaller than a second distance; and controlling the first drone and the second drone by using the GPS information, when the distance between the first drone and the second drone is greater than or equal to the second distance.

An electronic device according to various embodiments of the disclosure may include a communication module, wherein multiple first drones and multiple second drones may be controlled by the use of a sensor included in the second drones and GPS information, received through the communication module, of the multiple first drones and the multiple second drones, when the distance between the multiple first drones and the multiple second drones is greater than or equal to a first distance and is smaller than a second distance, and the multiple first drones and the multiple second drones may be controlled by the use of the GPS information, when the distance between the multiple first drones and the multiple second drones is greater than or equal to the second distance.

Multiple drones are connected to an electronic device according to various embodiments, and a method for operating the drones is provided on the basis of information on the connected drones. Therefore, a collision between the drones can be prevented, and a new type of content or information can be effectively generated by the operation of the drones.

### BRIEF DESCRIPTION OF THE DRAWINGS

FIG. 1 is a block diagram of an electronic device and a network according to various embodiments of the disclosure;

FIG. 2 is a block diagram of an electronic device according to various embodiments;

FIG. 3 is a block diagram of a program module according to various embodiments;

FIG. 4 is a conceptual view relating to determining areas for a drone according to various embodiments;

FIG. 5 is a conceptual view relating to determining area for a drone in another manner according to various embodiments;

FIG. 6 is another conceptual view relating to determining areas for a drone according to various embodiments;

FIG. 7 is a flow chart relating to pairing with drones according to various embodiments of the disclosure;

FIG. 8 is a conceptual view relating to information on a drone according to various embodiments of the disclosure;

FIG. 9 is a conceptual view relating to selection requirements for a first drone according to various embodiments of the disclosure;

FIG. 10 is another conceptual view relating to selection requirements for a first drone according to various embodiments of the disclosure;

FIG. 11 is a conceptual view relating to determining routes for a plurality of drones according to various embodiments of the disclosure;

FIG. 12 is a flow chart relating to performance of tasks of a plurality of drones according to various embodiments of the disclosure;

FIG. 13 is a flow chart of a method for performing pairing with a plurality of drones according to various embodiments of the disclosure;

FIG. 14 is a conceptual view relating to displaying an operation of pairing with a plurality of drones according to various embodiments of the disclosure;

FIG. 15 is a conceptual view relating to a method for selecting a first drone according to various embodiments of the disclosure;

FIG. 16 is a conceptual view relating to a method for selecting a plurality of drones and performing a task according to various embodiments of the disclosure;

FIG. 17 is a conceptual view relating to a method for changing the positions of a plurality of drones according to various embodiments of the disclosure;

FIG. 18 is a conceptual view relating to a method for transmitting a signal from an electronic device to a plurality of drones according to various embodiments of the disclosure;

FIG. 19 is a conceptual view relating to a method for capturing a panorama image according to various embodiments of the disclosure;

FIG. 20 is a flow chart relating to performing control for a method for capturing a panorama image according to various embodiments of the disclosure;

FIG. 21 is a conceptual view relating to vertical and horizontal photography according to various embodiments of the disclosure;

FIG. 22 is a conceptual view relating to three-dimensional photography according to various embodiments of the disclosure;

FIG. 23 is a conceptual view relating to a method for controlling a plurality of drones according to various embodiments of the disclosure;

FIG. 24 is a conceptual view relating to a method for controlling a plurality of drones in another manner according to various embodiments of the disclosure;

FIG. 25 is a flow chart of a method for transmitting content between an electronic device and a drone according to various embodiments of the disclosure;

FIG. 26 is a conceptual view illustrating a method for providing content by an electronic device according to various embodiments of the disclosure;

FIG. 27 is a conceptual view illustrating the inner structure of a drone according to various embodiments of the disclosure;

FIG. 28 is another conceptual view illustrating the inner structure of a drone according to various embodiments of the disclosure;

FIG. 29 is a flow chart of a drone control operation according to various embodiments of the disclosure;

FIG. 30 is a conceptual view relating to determining areas between sets of drones according to various embodiments of the disclosure;

FIG. 31 is a flow chart of an operation of determining areas between sets of drones according to various embodiments of the disclosure;

FIG. 32 is a flow chart of a method for controlling a plurality of drones according to various embodiments of the disclosure;

FIG. 33 is a flow chart of a method for controlling a plurality of drones according to another embodiment of the disclosure; and

FIG. 34 is a flow chart of a method for controlling a plurality of drones according to yet another embodiment of the disclosure.

### DETAILED DESCRIPTION

Hereinafter, various embodiments of the disclosure will be described with reference to the accompanying drawings. The embodiments and the terms used therein are not intended to limit the technology disclosed herein to specific forms, and should be understood to include various modifications, equivalents, and/or alternatives to the corresponding embodiments. In describing the drawings, similar reference numerals may be used to designate similar elements. A singular expression may include a plural expression unless they are definitely different in a context. As used herein, the expression “A or B” or “at least one of A and/or B” may include all possible combinations of items enumerated together. The expressions “a first”, “a second”, “the first”, or “the second” may modify various components regardless of the order or the importance, and is used merely to distinguish one element from any other element without limiting the corresponding elements. When an element (e.g. first element) is referred to as being “(functionally or communicatively) connected,” or “directly coupled” to another element (e.g. second element), the element may be connected directly to the another element or connected to the another element through yet another element third element).

The expression “configured to” as used in various embodiments of the disclosure may be used interchangeably with, for example, “suitable for”, “having the capacity to”, “designed to”, “adapted to”, “made to”, or “capable of” in terms of hardware or software, according to circumstances. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g. CPU or Application Processor (AP)) that can perform the corresponding operations by executing one or more software programs stored in a memory device.

An electronic device according to various embodiments of the disclosure may include, for example, at least one of a smart phone, a tablet PC, a mobile phone, a video phone, an electronic book reader, a desktop PC, a laptop PC, a netbook computer, a workstation, a server, a PDA, a Portable Multimedia Player (PMP), an MP3 player, a medical device, a camera, or a wearable device. According to various embodiments, the wearable device may include at least one of an accessory type (e.g. a watch, a ring, a bracelet, an anklet, a necklace, glasses, a contact lens, or a Head-Mounted Device (HMD)), a fabric or clothing integrated type (e.g. an electronic clothing), a body-mounted type (e.g. a skin pad or tattoo), or a bio-implantable circuit. In certain embodiments, the electronic device may include, for example, at least one of a television, a Digital Video Disk (DVD) player, an audio player, a refrigerator, an air conditioner, a vacuum cleaner, an oven, a microwave oven, a washing machine, an air cleaner, a set-top box, a home automation control panel, a security control panel, a media box (e.g. Samsung HomeSync™, Apple TV™, or Google TV™), a game console (e.g. Xbox™ and PlayStation™), an electronic dictionary, an electronic key, a camcorder, or an electronic photo frame.

In other embodiments, the electronic device may include at least one of various medical devices (e.g. various portable medical measuring devices (a blood glucose monitoring device, a heart rate monitoring device, a blood pressure measuring device, a body temperature measuring device, or the like), a Magnetic Resonance Angiography (MRA), a Magnetic Resonance Imaging (MRI), a Computed Tomography (CT) machine, an ultrasonic machine, or the like), a navigation device, a Global Navigation Satellite System (GNSS) receiver, an Event Data Recorder (EDR), a Flight Data Recorder (FDR), a Vehicle Infotainment Device, an electronic devices for a ship (e.g. a navigation device for a ship, a gyro-compass, etc.), avionics, security devices, a vehicular head unit, a robot for home or industry, a drone, an ATM in banks, Point Of Sales (POS) in a shop, or devices relating to Internet of things (e.g. a light bulb, various sensors, a sprinkler device, a tire alarm, a thermostat, a streetlamp, a toaster, a sporting good, a hot water tank, a heater, a boiler, etc.). According to certain embodiments, the electronic device may include at least one of a part of furniture, a building structure, or an automobile, an electronic board, an electronic signature receiving device, a projector, or various types of measuring instruments (e.g. a water meter, an electric meter, a gas meter, a radio wave meter, or the like), in various embodiments, the electronic device may be flexible, or may be a combination of one or more of the aforementioned various devices. The electronic device according to embodiments of the disclosure is not limited to the above-described devices. In the disclosure, the term “user” may indicate a person using an electronic device or a device (e.g. an artificial intelligence electronic device) using an electronic device.

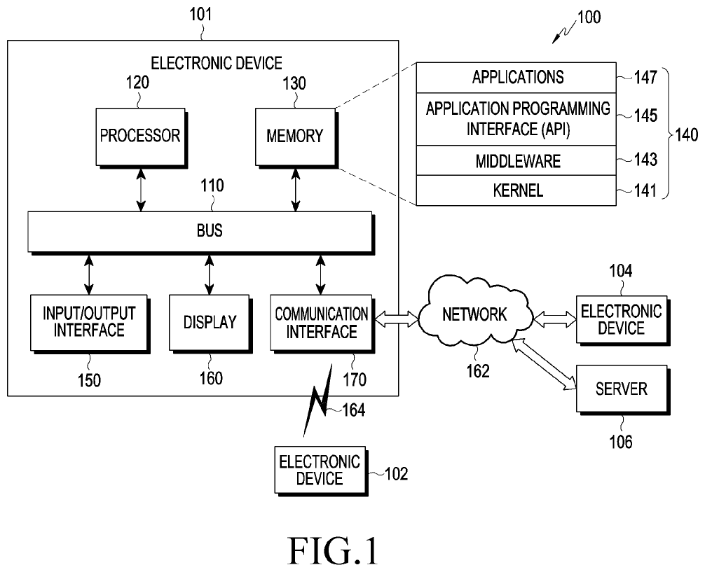

Referring to FIG. 1, an electronic device 101 within a network environment 100 according to various embodiments will be described. The electronic device 101 may include a bus 110, a processor 120, a memory 130, an input/output interface 150, a display 160, and a communication interface 170. In certain embodiments, the electronic device 101 may cope without at least one of the above elements or may further include other elements. The bus 110 may include a circuit connecting the elements 110 to 170 and transferring communication (e.g. control messages or data) between the elements. The processor 120 may include one or more of a central processing unit, an application processor, and a Communication Processor (CP). The processor 120, for example, may carry out operations or data processing relating to the control and/or communication of at least one other element of the electronic device 101.

The memory 130 may include a volatile memory and/or non-volatile memory. The memory 130 may store, for example, commands or data relating to at least one other element of the electronic device 101. According to an embodiment, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an operating system. The kernel 141 may control or manage system resources (e.g. the bus 110, the processor 120, or the memory 130) used for executing an operation or function implemented by other programs (e.g. the middleware 143, the API 145, or the application programs 147). The kernel 141 may provide an interface through which the middleware 143, the API 145, or the application programs 147 can control or manage the system resources by accessing the individual elements of the electronic device 101.

The middleware 143, for example, may function as an intermediary allowing the API 145 or the application programs 147 to communicate with the kernel 141 to transmit and receive data. The middleware 143 may process one or more task requests, received from the application programs 147, in order of priorities thereof. The middleware 143, for example, may assign, to one or more of the application programs 147, priorities for the use of the system resources (e.g. the bus 110, the processor 120, the memory 130, or the like) of the electronic device 101 and may process the one or more task requests. The API 145 is an interface through which the applications 147 control functions provided from the kernel 141 or the middleware 143, and may include, for example, at least one interface or function (e.g. instruction) for file control, window control, image processing, or text control. For example, the input/output interface 150 may deliver, to the other element(s) of the electronic device 101, commands or data input from a user or an external device or may output, to the user or the external device, commands or data received from the other element(s) of the electronic device 101.

The display 160 may include, for example, a Liquid Crystal Display (LCD), a Light Emitting Diode (LED) display, an Organic Light Emitting Diode (OLED) display, a. Micro Electro Mechanical System (MEMS) display, or an electronic paper display. The display 160, for example, may display various types of contents (e.g. text, images, videos, icons, and/or symbols) for a user. The display 160 may include a touch screen and receive, for example, a touch, gesture, proximity, or hovering input by means of an electronic pen or the user's body part. The communication interface 170, for example, may establish communication between the electronic device 101 and an external device (e.g. a first external electronic device 102, a second external electronic device 104, or a server 106). For example, the communication interface 170 may be connected to a network 162 through wireless or wired communication to communicate with the external device (e.g. the second external electronic device 104 or the server 106).

The wireless communication may include cellular communication that uses, for example, at least one of LTE, LTE-Advance (LTE-A), code division multiple access (CDMA), wideband CDMA (WCDMA), a universal mobile telecommunications system (UMTS), wireless broadband (WiBro), a global system for mobile communications (GSM), or the like. According to an embodiment, the wireless communication may include, for example, at least one of Wireless Fidelity (Wi-Fi), Bluetooth, Bluetooth low energy (BLE), ZigBee, near field communication (NFC), magnetic secure transmission, Radio Frequency (RF), and a body area network (BAN). According to an embodiment, the wired communication may include GNSS. The GNSS may be, for example, a Global Positioning System (GPS), a Global Navigation Satellite System (Glonass), a Beidou navigation satellite system (hereinafter referred to as “Beidou”), or Galileo, the European global satellite-based navigation system. Hereinafter, in this document, the “GPS” may be used interchangeably with the “GNSS”. The wired communication may include, for example, at least one of a Universal Serial Bus (USB), a High Definition Multimedia Interface (HDMI), Recommended Standard 232 (RS-232), power line communication, a Plain Old Telephone Service (POTS), or the like. The network 162 may include at least one telecommunications network, such as a computer network (e.g. a LAN or a WAN), the Internet, or a telephone network.

Each of the first and second external electronic devices 102 and 104 may be of a type identical to or different from that of the electronic device 101. According to various embodiments, all or certain of the operations executed in the electronic device 101 may be executed in another electronic device or a plurality of electronic devices (e.g. the electronic devices 102 and 104 or the server 106). According to an embodiment, when the electronic device 101 needs to perform certain functions or services automatically or by request, the electronic device 101, instead of or in addition to performing the functions or services by itself, may request another device (e.g. the electronic device 102 or 104 or the server 106) to perform at least a part of functions relating thereto. Another electronic device (e.g. the electronic device 102 or 104 or the server 106) may execute the requested functions or the additional functions and may deliver a result of the execution to the electronic apparatus 101. The electronic device 101 may provide the received result as it is or may additionally process the received result to provide the requested functions or services. To this end, for example, cloud computing, distributed computing client-server computing technology may be used.

The electronic device according to various embodiments may include a communication module, and a processor 120 configured such that, when the distance between a first drone and a second drone among a plurality of drones is greater than or equal to a first distance and is smaller than a second distance, the processor 120 controls the first drone and the second drone by using a sensor included in the second drone, and GPS information, received through the communication module, of the first drone and the second drone, but when the distance between the first drone and the second drone is greater than or equal to the second distance, the processor 120 controls the first drone and the second drone by using the GPS information.

In the electronic device according to various embodiments, the processor 120 may select the first drone on the basis of at least part of information on the first drone and second drone and task information and may perform control such that the second drone is positioned the first distance or more away from the selected first drone.

In the electronic device according to various embodiments, when the second drone is positioned in an area where a distance from the first drone is greater than the first distance and smaller than the second distance, the processor 120 may perform control such that the second drone measures the distance to the first drone by using at least one of an RGB sensor, an ultrasonic sensor, an IR sensor, and a BT signal, included in the second drone.

In the electronic device according to various embodiments, the processor 120 may determine the first distance on the basis of information on at least one of the size of the first drone, the speed of the first drone, an external force applied to the first drone, and the capability to compensate for an error in the position of the first drone.

In the electronic device according to various embodiments, the processor 120 may transmit a pairing request to at least one drone among the first drone and the second drone and may perform pairing with the at least one drone on the basis of an acceptance response from the at least one drone to the pairing request.

In the electronic device according to various embodiments, the processor 120 may determine an initial location of the first drone and determine a route for the second drone such that the second drone is at a distance of a first threshold value or more from the first drone which is in the initial location, and the communication module may transmit the route for the second drone and information on the initial location of the first drone to at least one of the first drone and second drone.

In the electronic device according to various embodiments, the electronic device may include a touch screen, and the processor 120 may display position information of the first drone and the second drone through the touch screen, receive position control information of the plurality of drones input from a user through the touch screen, and control the at least one drone according to the input information.

In the electronic device according to various embodiments, the processor 120 may determine weight values according to pieces of information relating to the first drone and establish higher priority when the sum of the weight values is greater.

In the electronic device according to various embodiments, when a master drone is changed from the first drone to the second drone, the processor 120 may perform control to transmit information on the master drone to the first drone and the second drone.

In the electronic device according to various embodiments, when the position of the first drone is changed, the processor 120 may control the plurality of drones to carry out the task by changing the positions of the plurality of drones.

The electronic device according to various embodiments may include a communication module, and a processor 120 configured such that, when the distance between a plurality of first drones and a plurality of second drones is greater than or equal to a first distance and is smaller than a second distance, the processor 120 controls the plurality of first drones and the plurality of second drones by using a sensor included in the second drones and GPS information, received through the communication module, of the plurality of first drones and the plurality of second drones, but when the distance between the plurality of first drones and the plurality of second drones is greater than or equal to the second distance, the processor 120 controls the plurality of first drones and the plurality of second drones by using the GPS information.

In the electronic device according to various embodiments, when the plurality of second drones is positioned in an area where a distance from the plurality of the first drones is greater than the first distance and is smaller than the second distance, the processor 120 may perform control such that the plurality of second drones measure the distance to the plurality of first drones by using at least one of RGB sensors, ultrasonic sensors, IR sensors, and BT signals, included in the plurality of second drones.

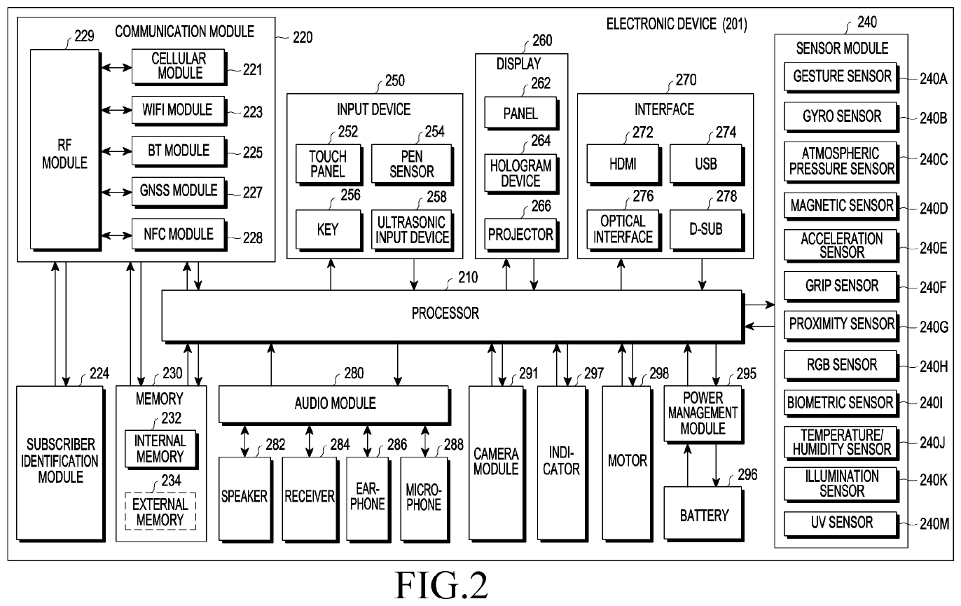

FIG. 2 is a block diagram of an electronic device 201 according to various embodiments. The electronic device 201 may include, for example, the whole or part of the electronic device 101 illustrated in FIG. 1. The electronic device 201 may include at least one processor 210 (e.g. an AP), a communication module 220, a subscriber identification module 224, a memory 230, a sensor module 240, an input device 250, a display 260, an interface 270, an audio module 280, a camera module 291, a power management module 295, a battery 296, an indicator 297, and a motor 298. The processor 210 may run, for example, an operating system or an application program to control multiple software components or hardware components connected to the processor 210 and perform various data processing and operations. The processor 210 may be configured by applying, for example, a System on Chip (SoC). According to an embodiment, the processor 210 may further include a Graphic Processing Unit (GPU) and/or an image signal processor. The processor 210 may also include at least part of the components illustrated in FIG. 2 (e.g. a cellular module 221). The processor 210 may load, into a volatile memory, commands or data received from at least one of the other elements (e.g. a non-volatile memory) and process the loaded commands or data, and may store resultant data in the non-volatile memory.

The communication module 220 may have a configuration identical or similar to that of the communication interface 170. The communication module 220 may include, for example, a cellular module 221, a Wi-Fi module 223, a Bluetooth module 225, a GNSS module 227, an NFC module 228, and a RF module 229. The cellular module 221 may provide, for example, a voice call, a video call, a text message service, an Internet service, or the like through a communication network. According to an embodiment, the cellular module 221 may identify and authenticate the electronic device 201 within a communication network by using the subscriber identification module 224 (e.g. a SIM card). According to an embodiment, the cellular module 221 may perform at least part of the functions provided by the processor 210. According to one embodiment, the cellular module 221 may include a Communication Processor (CP). According to a certain embodiment, at least some (e.g. two or more) of the cellular module 221, the Wi-Fi module 223, the Bluetooth module 225, the GNSS module 227, and the NFC module 228 may be included in one Integrated Chip (IC) or IC package. The RF module 229 may transmit/receive, for example, a communication signal (e.g. an RF signal). The RF module 229 may include, for example, a transceiver, a Power Amp Module (PAM), a frequency filter, a Low Noise Amplifier (LNA), an antenna, or the like. According to another embodiment, at least one of the cellular module 221, the Wi-Fi module 223, the Bluetooth module 225, the GNSS module 227, or the NFC module 228 may transmit/receive an RF signal through a separate RF module. The subscriber identification module 224 may include, for example, a card including a subscriber identification module or an embedded SIM and may contain unique identification information (e.g. an Integrated Circuit Card Identifier (ICCID)) or subscriber information (e.g. an International Mobile Subscriber Identity (IMSI)).

The memory 230 (e.g. the memory 130) may include, for example, an internal memory 232 or an external memory 234. The internal memory 232 may include, for example, at least one of a volatile memory (e.g. a DRAM, an SRAM, an SDRAM, or the like) and a non-volatile memory a One Time Programmable ROM (OTPROM), a PROM, an EPROM, an EEPROM, a mask ROM, a flash ROM, a flash memory, a hard disc drive, or a Solid State Drive (SSD)). An external memory 234 may further include a flash drive, such as a Compact Flash (CF), a Secure Digital (SD), a Micro-SD, a Mini-SD, an extreme Digital (xD), a multi-media card (MMC), and a memory stick. The external memory 234 may be functionally or physically connected to the electronic device 201 through various interfaces.

The sensor module 240 may, for example, measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g. a red, green, blue (RGB) sensor), a biometric sensor 240I, a temperature/humidity sensor 240J, a light sensor 240K, or a ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. In certain embodiments, the electronic device 201 may further include a processor configured to control the sensor module 240 as a part of or separately from the processor 210 and may control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer and provide a tactile reaction to a user. The (digital) pen sensor 254 may include, for example, a recognition sheet that is a part of or separate from the touch panel. The key 256 may include, for example, a physical button, an optical key or a keypad. The ultrasonic input device 258 may detect ultrasonic waves generated by an input unit, through a microphone (e.g. a microphone 288) and check data corresponding to the detected ultrasonic waves.

The display 260 (e.g. the display 160) may include a panel 262, a hologram device 264, a projector 266, and/or a control circuit configured to control the same. The panel 262 may be formed to be, for example, flexible, transparent, or wearable. The panel 262 may include the touch panel 252 and one or more modules. According to an embodiment, the panel 262 may include a pressure sensor (or force sensor) capable of measuring the pressure strength of the user's touch. The pressure sensor may be configured to be integrated with the touch panel 252 or may include one or more sensors separate from the touch panel 252. The hologram device 264 may show a three-dimensional image in the air by using interference of light. The projector 266 may display an image by projecting light onto a screen. The screen may be located, for example, inside or outside the electronic device 201. The interface 270 may include, for example, an HDMI 272, a USB 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a SD card/Multi-Media Card (MMC) interface, or an Infrared Data Association (IrDA) standard interface.

The audio module 280 may, for example, convert sound into an electrical signal, or vice versa. At least part of components of the audio module 280 may be included in, for example, the input/output interface 145 illustrated in FIG. 1. The audio module 280 may process sound information which is input or output through, for example, a speaker 282, a receiver 284, earphones 286, a microphone 288, or the like. The camera module 291 is a device which may capture a still image and a dynamic image. According to an embodiment, the camera module 291 may include one or more image sensors (e.g. a front sensor or a back sensor), a lens, an Image Signal Processor (ISP), or a flash (e.g. an LED, a xenon lamp, or the like). The power management module 29:5 may, for example, manage power of the electronic device 201. According to an embodiment, the power management module 295 may include a Power Management Integrated Circuit (PMIC), a charger IC, or a battery/fuel gauge. The PMIC may use a wired and/or wireless charging method. The wireless charging method may include, for example, a magnetic resonance method, a magnetic induction method, an electromagnetic method, etc. An additional circuit for wireless charging, such as a coil loop, a resonance circuit, a rectifier may be further included for the method. The battery gauge may measure, for example, a residual quantity of the battery 296, and a voltage, a current, or a temperature during the charging. The battery 296 may include, for example, a rechargeable battery and/or a solar battery.

The indicator 297 may display a particular state, for example, a booting state, a message state, a charging state, or the like of the electronic device 201 or a part (e.g. the processor 210) of the electronic device 201. The motor 298 may convert an electrical signal into mechanical vibration and generate vibration, a haptic effect, or the like. The electronic device 201 may, for example, include a mobile TV support device (e.g. a GPU) that can process media data according to a standard for digital multimedia broadcasting (DMB), digital video broadcasting (DVB), MediaFlo™, or the like. Each of the components described in the disclosure may include one or more component parts, and the name of the corresponding component may vary depending on a type of the electronic device. In various embodiments, an electronic device (e.g. the electronic device 201) may cope without some of the components or further include an additional component, or some of the components may be combined together to be configured into one entity, such that the electronic device may identically perform the functions of the corresponding components prior to the combination.

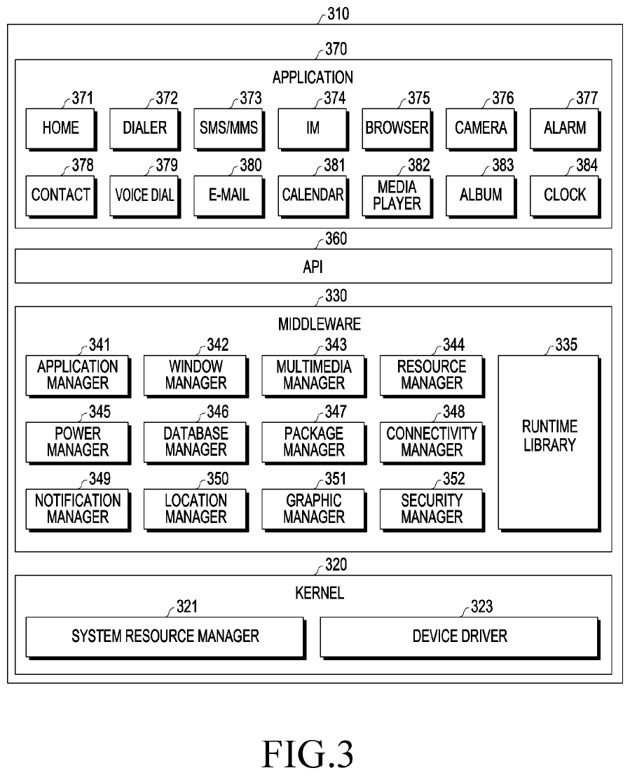

FIG. 3 is a block diagram of a program module according to various embodiments. According to an embodiment, the program module 310 (e.g. the program 140) may include an operating system configured to control resources related to an electronic device (e.g. the electronic device 101) and/or various applications (e.g. the application programs 147) executed in the operating system. The operating system may include, for example, Android™, iOS™, Windows™, Symbian™, Tizen™, or Bada™. Referring to FIG. 3, the program module 310 may include a kernel 320 (e.g. the kernel 141), middleware 330 (e.g. the middleware 143), an API 360 (e.g. the API 145), and/or applications 370 (e.g. the application programs 147). At least part of the program module 310 may be preloaded on the electronic device or may be downloaded from an external electronic device (e.g. the electronic device 102 or 104, the server 106, etc.).

The kernel 320 may include, for example, a system resource manager 321 and or a device driver 323. The system resource manager 321 may control, allocate, or retrieve system resources. According to an embodiment, the system resource manager 321 may include a process manager, a memory manager, or a file system manager. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver. The middleware 330 may, for example, provide a function required by the applications 370 in common or provide various functions to the applications 370 through the API 360 such that the applications 370 can use restricted system resources within the electronic device. According to an embodiment, the middleware 330 may include at least one of a runtime library 335, an application manager 341, a window manager 342, a multi-media manager 343, a resource manager 344, a power manager 345, a database manager 346, a package manager 347, a connectivity manager 348, a notification manager 349, a location manager 350, a graphic manager 351, or a security manager 352.

The runtime library 335 may include, for example, a library module that a compiler uses in order to add a new function according to a programming language while the applications 370 are being executed. The runtime library 335 may perform input/output management, perform memory management, or process an arithmetic function. The application manager 341 may manage, for example, the life cycles of the applications 370. The window manager 342 may manage GUI resources used for a screen. The multimedia manager 343 may identify formats required to reproduce media files and may encode or decode a media file by using a codec appropriate for the corresponding format of the media file. The resource manager 344 may manage the source code of or memory space for the applications 370. The power manager 345 may, for example, manage the capacity or power of a battery and provide power information required to operate the electronic device. According to an embodiment, the power manager 345 may interwork with a basic input/output system (BIOS). The database manager 346 may, for example, generate, search, or change databases to be used by the applications 370. The package manager 347 may manage the installation or update of an application distributed in the form of a package file.

The connectivity manager 348 may manage, for example, a wireless connection. The notification manager 349 may, for example, notify a user of an event, such as an arrival message, an appointment, a proximity notification, etc. The location manager 350 may manage, for example, location information of the electronic device. The graphic manager 351 may manage, for example, a graphic effect, which is to be provided to the user, or a user interface related to the graphic effect. The security manager 352 may provide, for example, system security or user authentication. According to an embodiment, the middleware 330 may include a telephony manager configured to manage a voice or video call function of the electronic device or a middleware module that can combine the functions of the components described above. According to an embodiment, the middle are 330 may provide modules specialized according to types of operation systems. The middleware 330 may dynamically remove existing components in part or add new components. The API 360 is, for example, a set of API programming functions and may be provided to have a configuration different depending on the operating system thereof. For example, in the case of Android or iOS, one API set may he provided for each platform, and in the case of Tizen, two or more API sets may be provided for each platform.

The applications 370 may include, for example, home 371, dialer 372, SMS/MMS 373, Instant Message (IM) 374, browser 375, camera 376, alarm 377, contacts 378, voice dial 379, e-mail 380, calendar 381, media player 382, album 383, watch 384, health care (e.g. measuring exercise amount, blood sugar, or the like), or environment information (e.g. atmospheric pressure, humidity, or temperature information). According to an embodiment, the applications 370 may include an information exchange application that can support the exchange of information between the electronic device and an external electronic device. The information exchange application may include, for example, a notification relay application configured to relay specific information to an external electronic device, or a device management application configured to manage an external electronic device. For example, the notification relay application may relay notification information generated in the other applications of the electronic device to an external electronic device or may receive notification information from an external electronic device to provide the received notification information to a user. The device management application may, for example, install, delete, or update a function of an external electronic device communicating with the electronic device (e.g. turning on/off the external electronic device itself (or a certain component thereof) or adjusting the luminance (or resolution) of a display) or applications operating in the external electronic device. According to an embodiment, the application 370 may include an application (e.g. a health care application of a mobile medical device) designated according to the attributes of an external electronic device. According to an embodiment, the application 370 may include an application received from an external electronic device. At least part of the program module 310 may be implemented (e.g. executed) by software, firmware, hardware (e.g. the processor 210), or a combination of two or more thereof and may include a module, a program, a routine, an instruction set, or a process for performing one or more functions.

The term “module” as used herein may include a unit consisting of hardware, software, or firmware, and may, for example, he used interchangeably with the term “logic”, “logical block”, “component”, “circuit”, or the like. The “module” may be an integrated component, or a minimum unit for performing one or more functions or a part thereof. The “module” may be mechanically or electronically implemented and may include, for example, an Application-Specific Integrated Circuit (ASIC) chip, a Field-Programmable (late Arrays (FPGAs), or a programmable-logic device, which are known or are to be developed in the future, for performing certain operations. At least some of devices (e.g. modules or functions thereof) or methods (e.g. operations) according to various embodiments may be implemented by an instruction which is stored a computer-readable storage medium (e.g. the memory 130) in the form of a program module. The instruction, when executed by a processor (e.g. the processor 120), may cause the processor to execute a function corresponding to the instruction. The computer-readable storage medium may include a hard disk, a floppy disk, a magnetic medium (e.g. a magnetic tape), an Optical Media (e.g. CD-ROM, DVD), a Magneto-Optical Media (e.g. a floptical disk), an inner memory, etc. The instruction may include a code made by a complier or a code that can be executed by an interpreter. The module or program module according to various embodiments may include one or more of the aforementioned components, cope without some of the aforementioned components, or further include any other component. Operations performed by the module, program module, or any other component according to various embodiments may be executed sequentially, in parallel, repeatedly, or heuristically, or at least some of the operations may be executed in a different order or omitted, or any other operation may be further included.

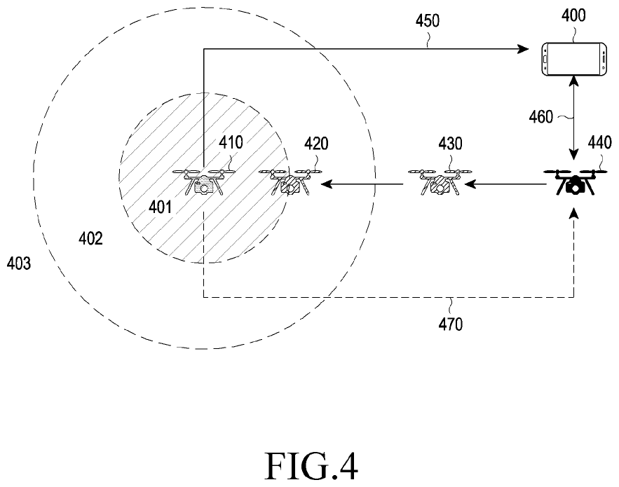

FIG. 4 is a conceptual view relating to determining areas for a drone according to various embodiments.

The electronic device according to various embodiments of the disclosure, in order to control a plurality of drones, may control the drones by determining a first area and a second area on the basis of a first distance and a second distance between each of the drones, so as to allow the plurality of drones to perform a task without collision therebetween. Referring to FIG. 4, the electronic device may communicate with a first drone 410 through a first communication channel 450 and communicate with a second drone 440 through a second communication channel 460. The electronic device may select, as a master drone, one of the first drone 410 and the second drone 440 on the basis of at least one of information on capabilities of the first drone 410 and second drone 440, and information on tasks to be performed by the first drone 410 and the second drone 440. For example, when the electronic device 400 determines the first drone 410 is the master drone, the electronic device may transmit and receive data to/from the first drone through the first communication channel 450 and select the first communication channel 450 as the master channel. The second drone 440 may be determined to be a slave drone, and the second communication channel 460 may be determined to be a slave channel. A processor 120 of the electronic device or processors mounted in the first drone 410 and second drone 420 may determine, with respect to each of the positions of the first drone 410 and second drone 420, a collision area where a distance therefrom is smaller than the first distance, a first area where a distance therefrom is greater than or equal to the first distance and an external drone is allowed to fly, and a second area which is an area posing risk of collision and where a distance therefrom is greater than or equal to the first distance and is smaller than the second distance.

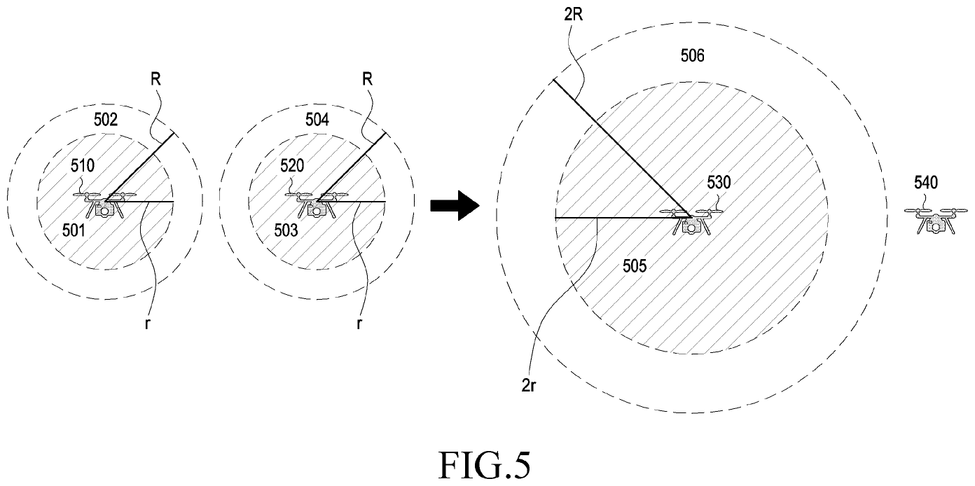

FIG. 5 is a conceptual view relating to determining an area for a drone in another manner according to various embodiments.

Referring to FIG. 5 to facilitate understanding, a collision area, a first area, and a second area may be determined for each of a first drone 510 and a second drone 520 among multiple drones. Specifically, with respect to the position of the first drone 510, a first collision area 501 where a distance therefrom is smaller than first distance r, a first area for the first drone 510 where a distance therefrom is greater than or equal to first distance r, and a second area 502 for the first drone 510 where a distance therefrom is greater than or equal to first distance r and is smaller than second distance R may be determined. With respect to the position of the second drone 520, a second collision area 502 where a distance therefrom is smaller than first distance r, a first area for the second drone 520 where a distance therefrom is greater than or equal to first distance r, and a second area 503 for the second drone 520 where a distance therefrom is greater than or equal to first distance r and is smaller than second distance R may be determined. From the point of view of the second drone 520, it is required to determine an area with respect to the position of the first drone 510 in order to maintain distance to the first drone 510. Therefore, a collision area 505 for the first drone 530 may be determined by a distance of 2r obtained by the arithmetic sum of first distance r from the first drone 510 and first distance r from the second drone 520. From the point of view of the second drone, the second drone may be expressed as a point. In the same manner, with respect to the position of the first drone 530, a first area for the first drone 530 where a distance therefrom is greater than or equal to first distance 2r, and a second area 506 where a distance therefrom is greater than or equal to first distance 2r and is smaller than second distance 2R may be determined as well. In the same manner, even when a new third drone (not illustrated) is added, a first area and a second area for the third drone (not illustrated) may be determined in the same manner as from the point of view of the second drone 540. The second drone 540 may generate a route in which collision with the first drone 530 and the third drone (not illustrated) can be avoided, and move therealong. Along with the drawings hereinafter provided, collision avoidance, etc. will be described on the basis of the first area and second area determined in the point of view of the second drone described in FIG. 5.

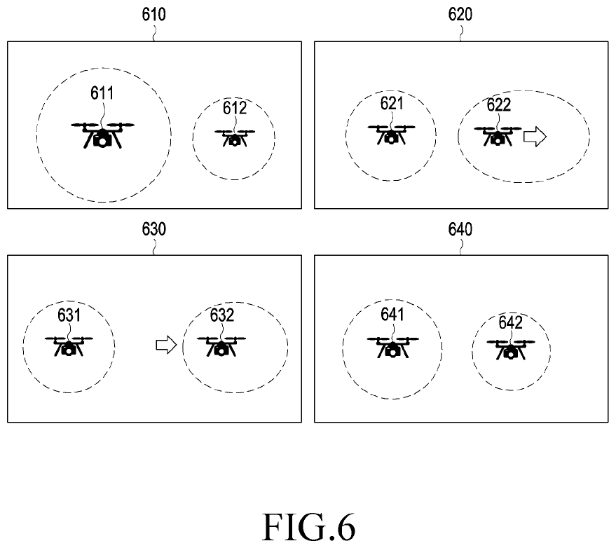

Referring to FIG. 4, to apply the area determination scheme in FIG. 5, the processor, in order to operate the plurality of drones, may determine, as a collision area 401, an area formed within the first distance of the first drone 410. The collision area 401 may be determined according to factors, such as the size of the first drone, the speed of the first drone, an external force applied to the first drone, the capability to compensate for a positional error, etc. Details of determination of the collision area 401 with respect to the first distance will be specifically described in the section for FIG. 6. Therefore, in order to avoid a collision with the first drone 410, the electronic device or the second drone 440 may determine a route for the second drone 440 such that the second drone 440 is not positioned in the collision area 401 for the first drone 410.

The electronic device according to various embodiments of the disclosure may determine, as the first area 402 and 403, an area where a distance from a first drone is greater than the first distance. That is, the electronic device or the second drone may determine the first area 402 and 403 such that the second drone is the first distance or snore away from the first drone 410, and determine a route for the second drone to avoid collision with the first drone 410 by performing control such that the second drone 420 operates in the first area 402 and 403 while flying. Within the first area 402 and 403, the second area 402 may be determined as an area where a distance from the first drone 410 is greater than or equal to the first distance and is smaller than the second distance and which poses risk of collision with the second drone 440.

When a route for the second drone 440 is determined by the processor 120 of the electronic device 400 or the second drone 440, the second drone 440 may perform a task, such as capturing of an image, collecting of sensor information, etc., while flying along the route. Then, the second drone flies avoiding the collision area 401 for the first drone 410. For example, suppose that the second drone 440 flying at a first position flies via a second position 430 to a third position 420. When the second drone 440 flies in the first position 440, the second position 430, or the like which is the second distance or more away from the first drone 410, the second drone 440 may measure the distance to the first drone 410 by using GPS information fundamentally. The distance between the first drone 410 and the second drone 440 may be measured by the first drone 410 in the same manner as well, and the first drone 410 and the second drone 440 may predict a degree of risk of collision on the basis of the measured distance. When the second drone 440 flies in the second area 402 by moving up to the third position 420, that is, the second drone 440 enters the second area 402, the second drone may accurately measure the distance from the first drone 410 by using, other than the GPS information, any information acquired by means of one of auxiliary sensors, such as a camera, an ultrasonic sensor, an Infrared (IR) sensor, a beacon signal sensor, etc., mounted in the second drone and may alter the flight route on the basis of the measured distance so as to avoid collision with the first drone 410. The scheme described above may be applied the same to the first drone 410. The second area 402 may be determined on the basis of GPS information, and when a GPS error ranges, for example, between 1-2 meters, the second distance, which is the radius of the second area 402, may be determined to be at least two meters. If the GPS error ranges between 0 to the first distance, the collision area 401 and the second area 402 may be the same.

The first drone 410 and the second drone 440 may transmit and receive data through a communication channel 470 established therebetween, even though the electronic device is not used. That is, even though the processor of the electronic device does not directly control the first drone 410 and the second drone 4440, a processor mounted in each of the drones may directly determine the areas according to the distance therebetween and alter a route according to the distance.

FIG. 6 is a conceptual view relating to determining a collision area for a drone according to various embodiments.

As described above, the collision area 401 determined according to the first distance may be determined according to at least one factor among the size of the first drone, the speed of the first drone, an external force applied to the first drone, the capability to compensate for an error in the position of the first drone. Referring to FIG. 6, a change of a collision area according to the size of the first drone is illustrated in rectangle 610. A drone 611 may measure, for example, 50 cm in radius, a drone 612 may measure 20 cm in radius, and the first distances from the drones and the collision areas according to the first distances may be differently determined according to the radii. If the other conditions except for the size of the drones are the same, when the size of a drone grows, an area where collision may occur also grows, and thus the collision area also grows. As illustrated in FIG. 6, the first distance of and the collision area for the first drone 611 may be determined to be greater than the collision area for the drone 612 smaller in size. As in rectangle 620, the collision area may be determined according to the speed of a drone. A drone 621 may intend to move to the right together with a drone 622 in which case the drone 622 would have a higher probability of collision in the area positioned to the right. Therefore, the first distance of and the collision area for the drone 622 that is moving to the right may be determined to be greater in the right direction. The collision area may be also changed according to an external force applied to a drone. That is, the first distance may not indicate a certain direction of or a constant distance from a drone but indicate a distance varying depending on a direction. Although the conditions of drones themselves are the same, a drone 632 is affected by an external force, such as wind, from the left differently from a drone 631. Therefore, the collision area may be determined to be greater in a direction in which an external force is applied, in the same manner as in a change of the collision area according to movements of the drones in rectangle 620. Since an initial location is determined for each drone, an error may result therefrom. As in rectangle 640, the degrees of the capabilities to compensate for the error of drones vary according to the output of motors thereof. A drone 641 with smaller motor output may have a lower degree of capability to compensate for the error, compared with a drone 642 with greater motor output. Therefore, the processor 120 may determine a smaller collision area for the drone 642 with greater motor output.

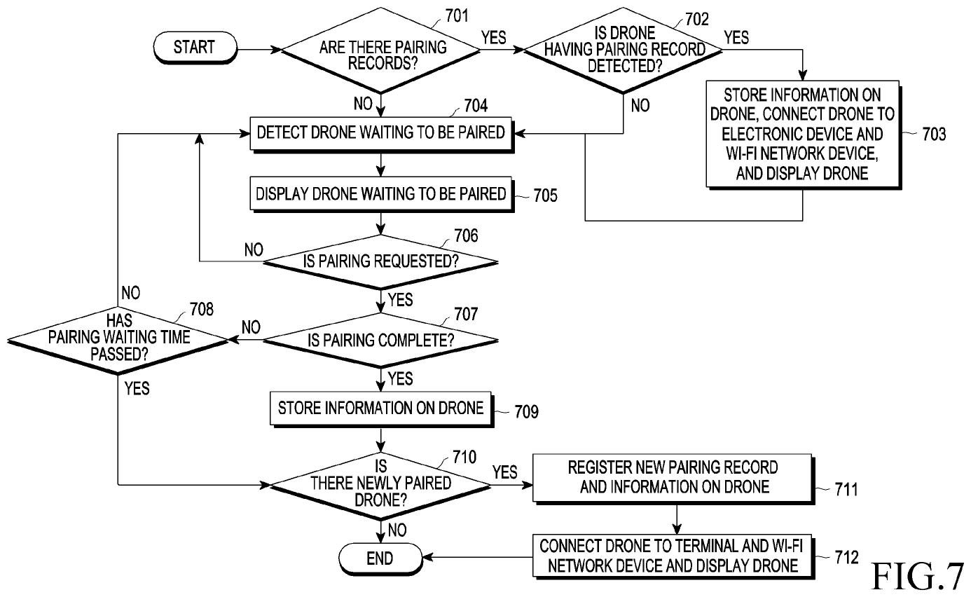

FIG. 7 is a flow chart of a pairing process between an electronic device and a plurality of drones according to various embodiments of the disclosure.

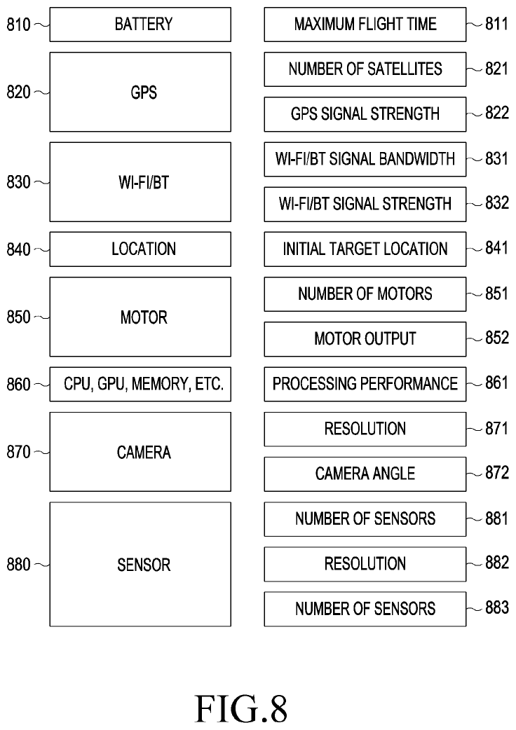

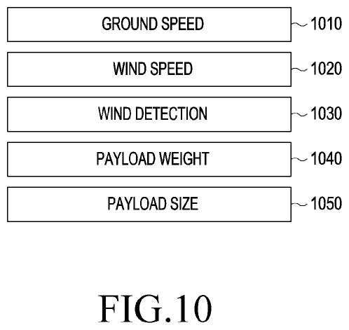

In various embodiments, the electronic device may communicate with a plurality of drones through a communication module. Before the communication, the electronic device may be subjected to a process of registering and pairing the plurality of drones with the electronic device. The communication module may transmit a pairing request to at least one drone, and the processor 120 may perform pairing with the at least one drone according to an acceptance response to the pairing request. In operation 701, the processor 120 may search for whether there are pairing records of drones. When pairing records are found, the processor 120, in operation 702, may determine whether the detected drone is among the drones having the pairing records. When a pairing record of the corresponding drone is found, the processor 120, in operation 703, may store information on the detected drone in a memory or update the memory with the information and connect the drone to the electronic device and a Wi-Fi network device and display the connected drone. The information on the drone will be specifically described in FIGS. 8 and 10. When a new drone having no pairing record is detected, the processor 120, in operation 704, may search for a drone waiting to be paired. When searching is complete, the processor 120, in operation 705, may display through a display a drone waiting to be paired. The processor 120 may transmit a pairing request to at least one drone in operation 706, finish pairing with the drone in operation 707, and store, in the memory, information related to the drone having been paired, in operation 709. When the pairing request is not transmitted, the processor may search again for a drone waiting to be paired. When pairing is not complete despite the transmission of a pairing request, the processor 120 may determine in operation 708 whether a pairing waiting time has passed. When the pairing waiting time has not passed, the processor 120 may search again for a drone waiting to be paired in operation 704. When the pairing waiting time has passed, the processor may determine whether there is a newly paired drone.

When pairing is complete and then information on the paired drone is stored, or the pairing waiting time has passed, with no drone paired, the processor may determine in operation 610 whether there is a newly paired drone. When a newly paired drone other than drones having previously stored records is among the drones having been paired, the processor 120 may register a new pairing record and information on the drone in operation 6711, and the processor 120 may establish a connection to the drone through a network and display the drone by means of the display in operation 6712.

FIG. 8 is a conceptual view relating to information on a drone according to various embodiments of the disclosure.

When a drone is paired, a memory of the electronic device may store pieces of information on the corresponding drone. A processor 120 may select a first drone by using the corresponding information and determine a first distance and a second distance of the first drone. Various pieces of information on a drone may be presented as in FIG. 8. However, the information serves only as an example and the disclosure is not limited thereto. The information on a drone may be broadly divided into variable information perpetually varying depending on the drone, fixed information determined according to the main attributes of the drone, and the other environmental information. Referring to FIG. 8 information on a battery 810, a GPS signal 820, Wi-Fi/BT 830, a location 840 may fall under the variable information, and information on a motor 850, a hardware component 860, such as a CPU, a GPU, a memory, a camera 870, and a sensor 880 may fall under the fixed information. The charge level of the battery 810 may vary, and a maximum flight time 811 may be determined according to the remaining charge level of the battery. While a GPS 820 signal is received, the number of satellites 821 or GPS signal strength 822 may be flexibly changed and may be used as the information on the drone. The Wi-Fi/BT signal 830 may vary according to the signal frequency bandwidth 831 or the signal strength 832 of the signal. The location 840 information may include information on an initial location 841 determined for a plurality of drones to perform a task.

The motor 850 information, which is a part of the information falling under the fixed information, may include information on the number of motors 851 and a motor output 852. Information on hardware, such as a CPU, a GPU, and a memory, may vary depending on the processing performance 861 thereof The camera information 870 may vary according to the resolution 871 and angle information 872 thereof, and the sensor 880 information may include the number of sensors 881, a sensor resolution 882, and a frequency 883.

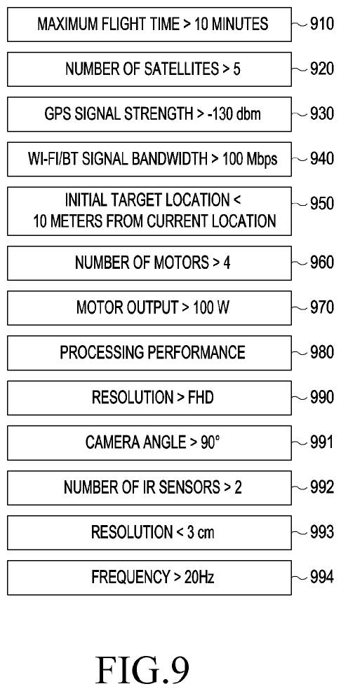

FIG. 9 illustrates exemplary selection requirements for a first drone according to various embodiments of the disclosure.

In the electronic device according to various embodiments, the processor 120 may select a first drone from a plurality of drones on the basis of the drone-related information and task-related information. FIG. 9 illustrates exemplary criteria for selecting a first drone, and selecting a first drone according to the disclosure is not limited thereto. For example, the criteria may require that the maximum flight time be longer than 10 minutes 910, and the number of satellites be greater than five 920. The criteria may also require that the GPS signal strength be greater than −130 dBm 930, and the Wi-fi/BT bandwidth be greater than 100 Mbps 940. The criteria may also require that the initial target location be within 10 meters of the current location 950, the number of motors be greater than four 960, and the motor output be greater than 100 watts 970. The criteria may also require that the processing performance be greater than or equal to a predetermined value 980, the resolution be greater than FDH 990, the camera angle be greater than 90 degrees 991, the number of IR sensors be greater than two 992, the resolution be smaller than 3 cm, and the frequency be greater than 20 kHz. The processor may determine whether each of the drones satisfies these requirements. When certain drones satisfy the requirements, the processor may assign weight values to each of the requirements, calculate the sum of the weight values of each of the drones, and select a drone having the highest value as the first drone.

FIG. 10 is another conceptual view relating to selection requirements for a first drone according to various embodiments of the disclosure. The selection requirements for the first drone may include the conditions of environments around a drone as well. The processor 120 may select the first drone or determine a first distance and a second distance of the first drone by using information on, for example, a ground speed 1010, a wind speed 1020 around the drone, wind 1030 detected by the drone, a payload weight 1040 relating to the weight of a carrying load, and a payload size 1050 relating to the size of the carrying load.

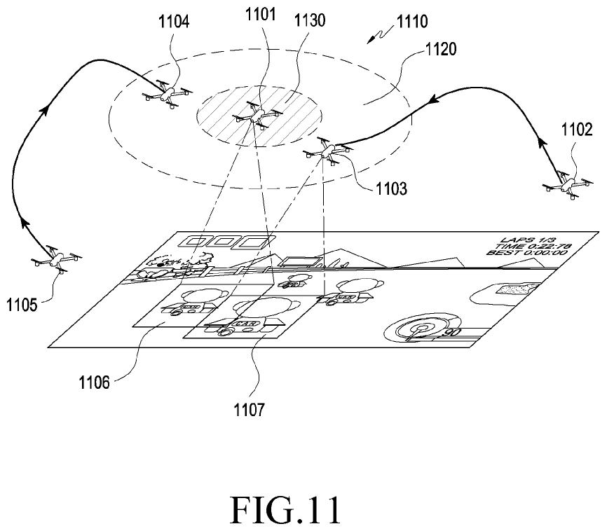

FIG. 11 is a conceptual view relating to determining routes for second drones according to various embodiments of the disclosure.

According to various embodiments, the processor 120 may determine a task to be performed by a first drone 1101 and a plurality of second drones 1102 and 1105, and an initial location of the first drone 1101. The task may denote every assignment to be performed by the first drone 1101 and the second drones 1102 and 1105 during flight under the control of the processor 120, for example, photographing to be performed by the first drone 1101 and the plurality of the second drones 1102 and 1105. Routes for the plurality of second drones 1102 and 1105 may be determined such that the second drones are positioned the first distance or more away from the first drone 1101 positioning in the initial location, and the communication module may transmit information on the initial location of the first drone and the routes for the second drones 1102 and 1105 to at least one drone among the plurality of second drones 1102 and 1105.

The first drone 1101 may determine a first distance and a second distance with respect to the initial location of the first drone 1101 and determine a collision area 1130, a first area 1110 and 1120, and a second area 1120 according to the first distance and the second distance. When a route for and the areas for the first drone 1101 have been determined and the first drone 1101 has moved to the initial location, routes for the plurality of second drones 1102 and 1105 except for the first drone 1101 may be determined on the basis of the first area and second area, and information on the first drone 1101 may be transmitted to the electronic device (not illustrated) and the plurality of second drones 1102 and 1105. That is, the first drone 1101 and the plurality f second drones 1102 and 1105 may determine flight routes such that the routes for the plurality of second drones 1102 and 1105 are not positioned within the collision area 1130 which is formed within a first distance of the first drone 1101. When the second drones 1102 and 1105 in flight in various initial locations receive the information on the location of the first drone 1101, the second drones may move up to final locations 1103 and 1104 of the second drones along the determined routes.

The second drones 1102 and 1105 flying in the initial locations may detect, while moving, entry into the second area 1120 where a distance from the first drone is greater than or equal to the first distance and is smaller than the second distance. While moving to the final locations 1103 and 1104 along the flight routes, when the plurality of second drones 1102 and 1105 detect entry into the second area 1120, the plurality of second drones 1102 and 1105 may measure a proximal distance from the first drone 1101 by using at least one of an RGB sensor, an ultrasonic sensor, an IR sensor, and a BT signal. Otherwise the distance from the first drone 1101 may be measured by the use of Optical Flow Sensor (OFS) images 1106 and 1107. The plurality of second drones 1102 and 1105 can measure a distance from the first drone 1101 by using various kinds of sensors of the second drones, thereby accurately measuring the distance from the first drone 1101 and flying without entering the collision area 1130.

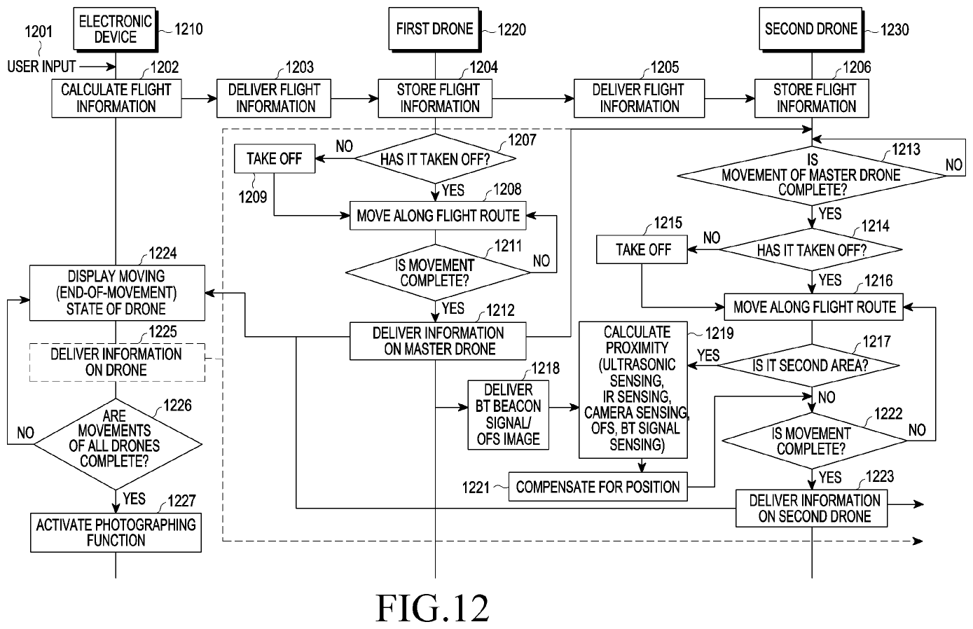

FIG. 12 is a flow chart relating to the performance of a task of a second drone according to various embodiments of the disclosure.

In operation 1201 illustrated in FIG. 12, when received a command to start a task of a plurality of drones from a user, an electronic device 1210 may generate flight information by calculating a flight order and flight trajectories of a plurality of drones required to perform the task. In operation 1202, the electronic device 1210 may transmit the generated flight information to a first drone 1220. The flight information may be transmitted to a second drone 1230 by the first drone 1220 in operation 1205, or the electronic device 1210 may directly transmit the flight information to the second drone 1230 as well. The first drone 1220 and second drone 1230 having received the flight information may store the flight information.

In operation 1204, the first drone 1220 having stored the flight information may check in operation 1207 whether the first drone has taken off. The first drone may take off in operation 1209 when it is determined that the first drone has not taken off. When the first drone 1220 has taken off, the first drone may move along a flight route in operation 1208. When it is determined in operation 1211 that the movement of the first drone is complete, information on the master drone may be transmitted to the electronic device 1210, the second drone 1230, and a third drone (not illustrated) in operation 1212. When in operation 1206 the second drone 1230 has stored the flight information and has received the information on the master drone, the second drone 1230 may check in operation 1213 whether the movement of the master drone is complete. When the movement of the master drone is complete, the second drone may check in operation 1214 whether to have taken off. The second drone may take off in operation 1215 when the second drone has not taken off, and may move along a flight route in operation 1216. While moving along the flight route, the second drone 1230 may check in operation 1217 whether the second drone has entered the second area. When it is determined that the second drone 1230 is in the second area, the second drone, in operation 1219, may calculate a proximal distance from the first drone 1220 by using an ultrasonic sensor, an IR sensor, a camera sensor, an OFS, a BT signal, etc. Then, the first drone, in operation 1218, may also transmit a BT Beacon signal, an OFS image, etc. to the second drone, and the first drone 1220 and the second drone 1230, in operation 1221, may compensate for the positions thereof according to the calculated distance. When a compensation for the positions has been made or while flying along the flight route, the second drone 1230 may check in operation 1222 whether the movement thereof is complete. When it is determined that the movement is not complete, the second drone may return to operation 1216 and move along the flight route. When it is determined that the movement is complete, information on the second drone may be transmitted to the electronic device 1210 and the third drone (not illustrated) in operation 1223. In the electronic device 1210, a moving state or an end-of-movement state of the drones may be displayed through a display in operation 1224. The electronic device 1210, in operation 1225, may also transmit information on a moving drone or a moved drone to the first drone 1220, the second drone 1230, or the third drone (not illustrated). When the electronic device 1210 determines in operation 1226 that movements of all the drones are complete, the electronic device may activate a photographing function in operation 1227,

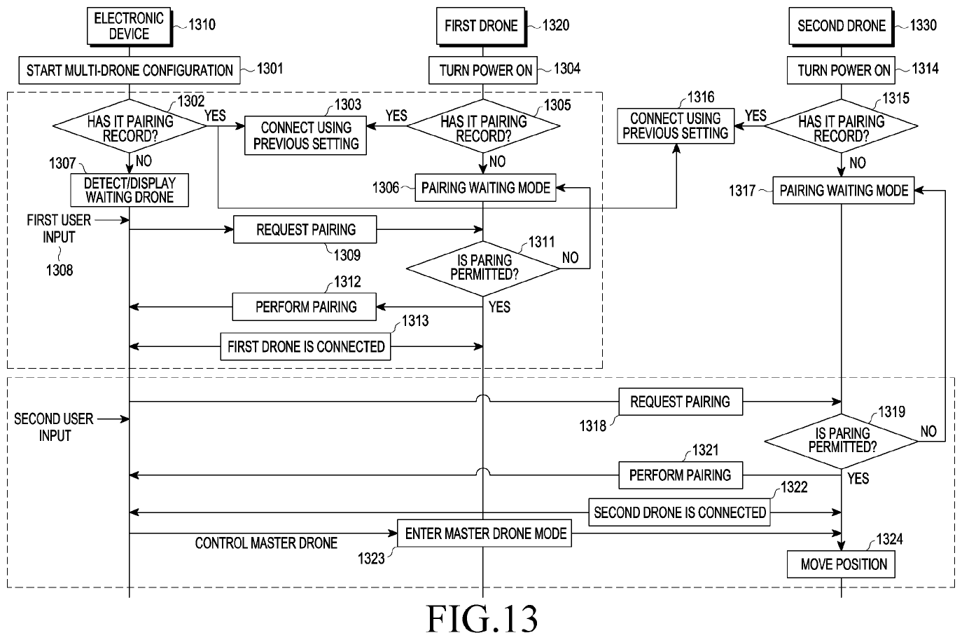

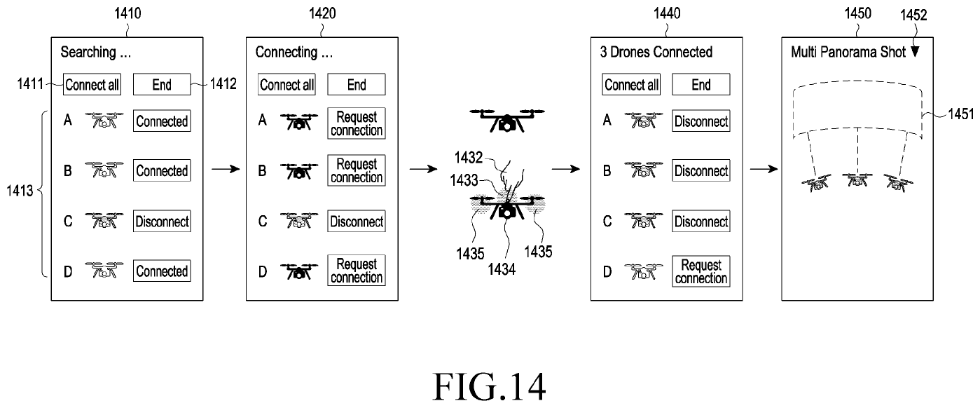

FIG. 13 is a flow chart of a method for performing pairing with a plurality of drones according to various embodiments of the disclosure. FIG. 14 is a conceptual view relating to displaying an operation of pairing with a plurality of drones according to various embodiments of the disclosure.

Referring to FIG. 13, an electronic device 1310 may start a multi-drone configuration in operation 1301. The electronic device 1310 may search for a drone having a pairing record. After searching pairing records, when it is determined that there is a pairing record with a first drone 1320, the electronic device 1310 may establish a connection in operation 1303 by using a previous setting. When a pairing connection to a drone having a pairing record is established, the pairing record may be compared with basic information on the drone stored in advance and be updated, whereby a multi-drone mode can be quickly set. On the other hand, in a case of a newly paired drone, other than the setting of the multi-mode, analysis of acquired information and provision of an index code of the new drone may be performed. For checking of a pairing record, pairing information, such as basic information of the drone or telephone numbers of other electronic devices, may be checked. The electronic device may perform pairing with the drone by comparing and analyzing the checked information and current information stored in the electronic device and then matching current properties stored in a storage device thereof with the connected drone. A drone having a pairing record may be automatically connected, and when the first drone has no pairing record, the electronic device 1310, in operation 1310, may detect a drone in a pairing waiting state and display the detected drone together with the connected drone (1410). From the point of view of the first drone 1320, when power is turned on in operation 1304, the first drone may check in operation 1305 whether to have a pairing record with the electronic device 1310, and may establish a connection in operation 1303 by using a previous setting, when the pairing record is found. When no pairing record is found, the first drone may enter a pairing waiting mode in operation 1306.

According to various embodiments, in a multi-drone connection process, another person's drone may be detected in the pairing operation, and when the pairing is permitted, primary user information and drone information recorded in the drone are accessible. The primary user information is used to compare with telephone number information registered in a mobile device, and when an information match is found, a corresponding user name may be displayed instead of the name of the drone. When no information match is found, the telephone number or the name of the drone is displayed. Otherwise, in the pairing operation, the drone information may be used to compare user information registered in a server with telephone number information registered in the mobile device so as to display corresponding information. A user may change the displayed name of the drone and record the changed name and the primary user information, with the name and information associated with each other, so that the drone name is still maintained for connections thereafter.

When a first user input is received in operation 1308, the electronic device 1310, in operation 1309, may transmit pairing requests at the same time to a plurality of drones 1413 which are in the pairing waiting state or are already connected (1411) or individually transmit the requests, and may wait until connections thereto are established (1420). Otherwise, pairing connections may be terminated as in operation 1412 illustrated in FIG. 14. The first drone 1320 or 1434 having received a pairing request from the electronic device 1310 may inform the user of a state related to the request by means of an LED 1435 or sound. In operation 1311, the first drone 1320 may permit a pairing connection in response to the pairing request. In order to permit the connection, various methods may be possible. For example, a user 1432 may press a particular button 1433 on the drone. When pairing is permitted by the first drone 1320, the electronic device 1310 may receive information on the first drone (a drone ID, drone capabilities, a drone location, a battery charge level, user information, etc.). When the electronic device 1310 and the first drone 1320 are paired in operation 1312, the first drone 1320 may be connected to the electronic device 1310 in operation 1313 by a technique such as a Wi-Fi network. When the first drone 1320 has been connected to the electronic device 1310, an operation for an initial configuration for the drone may subsequently begin to perform a function of determining an initial location of the drone, a function of determining a master drone, and the like. When the drone has been paired with the electronic device 1310, the electronic device may display drone connection states as in display 1440 illustrated in FIG. 14 and may display a task 1452 to be performed and a plurality of drones configured to perform the task as in display 1450 illustrated in FIG. 14.

The same operation may apply for a second drone 1330 as well. When the power of the second drone is turned on 1314, the electronic device may search pairing records in operation 1302. When the pairing record with the second drone 1330 is found in operation 1315, a connection may be established using a previous setting in operation 1316. When no pairing record with the second drone 1330 is found, the mode thereof may be switched to the pairing waiting mode in operation 1317. In operation 1318, a pairing request may be received from the second drone 1330, and in operation 1319 the pairing may be permitted through the same operation as used for the first drone 1320. After the pairing is performed in operation 1321, when a connection between the electronic device and the second drone 1330 has been established, the first drone 1320 may enter a master drone mode and the electronic device 1310 may control the master drone. When the first drone 1320 enters the master drone mode in operation 1323, the position of the second drone 1330 may be moved on the basis of the position of the first drone 1320 in operation 1324.

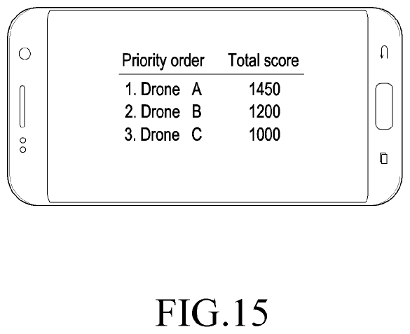

FIG. 15 is a conceptual view relating to a method for selecting a first drone according to various embodiments of the disclosure.

To easily control a plurality of drones even if the number of drones increases, it may be necessary to select a first drone, that is, a master drone in the operation of performing pairing with a plurality of drones. According to various embodiments, the processor 120 may determine weight values according to respective pieces of information related to each of the plurality of drones and respective tasks to be performed by the plurality of drones and may establish higher priority when the sum of the weight values is greater. As described in FIGS. 8 to 10, the processor 120 may determine weight values according to respective pieces of information on a drone or respective pieces of information on a task and calculate the sum of the determined weight values. As a result, each total score may be calculated by the sum of the weight values of each of a plurality of drones, for example, drones A, B, and C as illustrated in FIG. 15. Of the drones, a drone with the highest sum of the weight values may be determined as the first drone, that is, a master drone.

In Table 1, the weight values assigned to the elements in FIG. 9 related to the description above will be described for example.

TABLE 1
Weights assigned to elements used for selecting a master drone

| Element | Weight (%) |
|---|---|
| Maximum flight time | 300 |
| Number of satellites | 100 |
| GPS signal strength | 100 |
| Wi-Fi/BT bandwidth | 150 |
| Initial target location | 100 |
| Number of motors | 50 |
| Motor output | 50 |
| Processing performance | 50 |
| Resolution | 150 |
| Camera angle | 50 |
| Number of IR sensors | 50 |
| Resolution | 100 |
| Frequency | 100 |

Scores according to the elements are calculated by multiplying the weight values proportionally with respect to respective drones recording the highest values according to the elements, and a score for the master drone may be calculated by the sum of the scores according to the elements. For example, if the respective maximum flight times of drones A, B, and C are 30 minutes, 20 minutes, and 10 minutes, since the weight value of the maximum flight time is 300%, respective element scores may be calculated at 300 for drone A due to the longest operable time of 30 minutes, 200 for drone B, and 100 for drone C, proportionally. In this manner, the respective sums of the scores of the remaining elements may be calculated, a candidate order for the master drone may be arranged on the basis of the total scores, and a drone with the highest score among the candidates may be selected as the master drone. In this manner, when a master drone is selected, if panorama image capture is performed, a plurality of drones with similar camera capabilities may be recommended and a drone with a high battery charge level among the drones may be selected as the master drone, and if following flying is performed, three drones with similar thrust may be selected and of the drones a drone having an installed sensor with high sensitivity may be selected as the master drone. The master drone may be positioned in a reference position as a representative of the plurality of drones and may take charge of starting and ending of a task when the task is performed. The master drone may also receive, from a user, a signal related to the control of the plurality of drones and transmit the signal to each of the plurality of drones. The user may also directly transmit the signal to each of the plurality of drones.

According to various embodiments, the processor 120, when the first drone (master drone) is changed to a drone among the plurality of drones, the communication interface may transmit information related to the change of the first drone, to the plurality of drones. During a task, the first drone may be changed to one of the plurality of drones. For example, the first drone can be changed to one of the plurality of drones paired with the electronic device if the user tries to change the first drone, the connection between the electronic device and the first drone is broken, or the battery of the first drone is so low that it is impossible to perform the task.

According to various embodiments, when the location of the first drone is changed, the processor 120 may generate a signal to perform control such that the plurality of drones change the locations thereof and perform the task, and the communication interface may transmit the signal to at least one of the plurality of drones. When it is necessary for the first drone to be changed, the first drone may notify the user's electronic device that it is necessary for the first drone to be changed. The first drone may also transmit information on a drone to be changed to the first drone, to the user's electronic device and the plurality of drones. When the positions of the former first drone and current first drone are required to be swapped, the drones may move to each other's positions, generate movement information, and transmit the generated information to the electronic device and the plurality of drones.

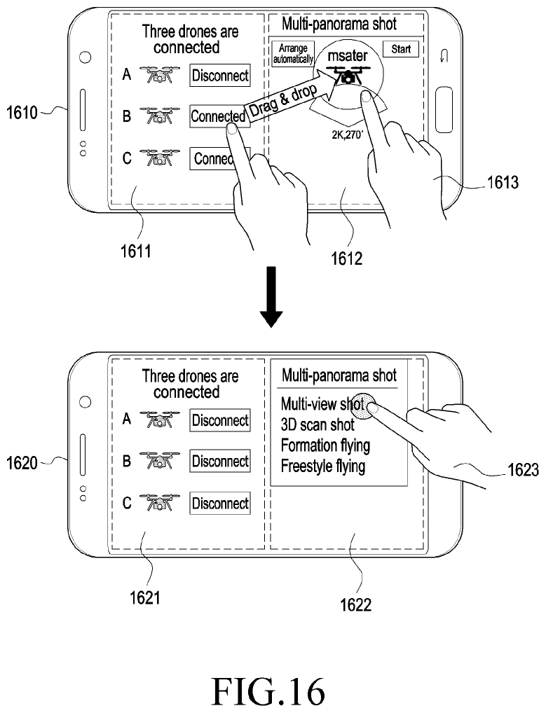

FIG. 16 is a conceptual view relating to a method for selecting a plurality of drones and performing a task according to various embodiments of the disclosure.

A plurality of drones (three drones in FIG. 16) paired with a current electronic device 1610 may be displayed in a first window 1611 of the electronic device 1610, a user 1613 may select one of the plurality of drones, drag and drop the selected drone so as to place the same in a window 1612, or may arrange the drones automatically in the window 1612 by touching the “Arrange automatically” button. A task, for example, “Multi-panorama shot” as in FIG. 16 to be performed by the drones, may be displayed in the second window 1612, and the task may be a default value or a mode performed before. For each displayed task, the user may select drones to be arranged and arrange the same. The electronic device 1610 may display a guide, used for relatively arranging the plurality of drones according to the task, through a display by using a graphic user interface. On the basis of locations in which the drones are to be placed on the automatic arrangement, the electronic device 1610 may display a boundary in which each of the drones can be placed, within a color range of the graphic user interface. The distances and angles between the drones may be displayed in the second window as the locations of the drones are changed. After the drones are arranged, the position of each of the drones may be moved by a user input using a drag and drop technique, through the graphic user interface.

After the drones are arranged in the second window 1612 of the electronic device 1610, a task changing operation may be performed as illustrated in the second window 1622 of the electronic device 1620. Drones having been paired may be displayed in the first window 1621, and one of the tasks may be selected in the second window 1622 through a touch screen by the user 1623. As illustrated in FIG. 16, the user 1623 may input a task through touch screen by selecting one of “Multi-view shot”, “3D scan shot”, “Formation flying”, “Path-following flying”, and “Freestyle flying”. When the electronic device 1620 receives the task input through the touch screen, the processor 120 may generate task information and control the drones. The electronic device 1620 may also provide, through the display, a graphic user interface used to arrange the plurality of drones according to the task.

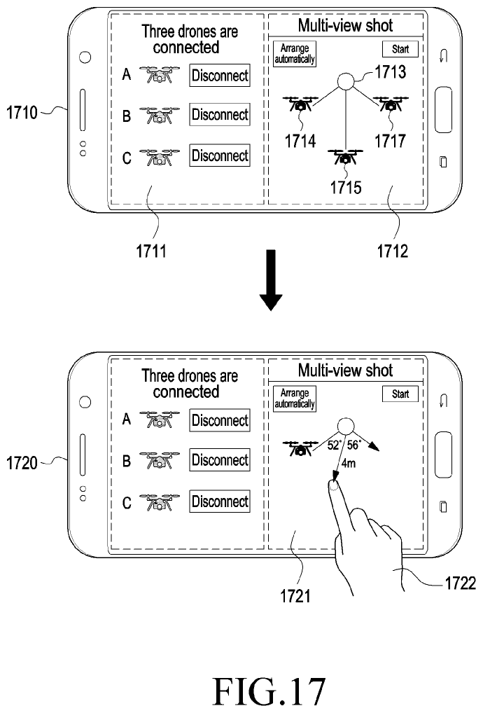

FIG. 17 is a conceptual view relating to a method for changing the positions of a plurality of drones according to various embodiments of the disclosure.

According to various embodiments, the electronic device 1710 may include a touch screen, and the processor 120 may display information on the positions of the plurality of drones through the touch screen, receive, as an input, information on position changes of the plurality of drones from a user through the touch screen, and generate a signal controlling at least one of the plurality of drones according to the input information.

Referring to FIG. 17, a first window 1711 and a second window 1712 are provided for the electronic device 1710. Information on connections to drones A, B, and C may be displayed in the first window 1711, and a target 1713, a plurality of drones 1714, 1715, and 1716 performing a task, and the task, which has been selected as “Multi-view shot”, may be displayed in the second window 1712. When a plurality of drones are arranged as illustrated in the second window 1712 of the electronic device 1710, the positions of the plurality of drones may be changed by dragging and dropping the drones as illustrated in the second window 1721 of the electronic device 1720. While changing a position, a user 1722 may change a numerical value relating to the position. For example, the distances between the target 1713 and the drones 1714, 1715, and 1716, the angles between the target 1713 and the drones 1714, 1715, and 1716, the distances between the drones 1714, 1715, and 1716, the distances between the electronic device and the drones 1714, 1715, and 1716, etc. may be displayed on the display, and the user may change the corresponding numerical values. When the “Start” button is touched, the task is performed in compliance with information on the task and the relative positions of the plurality of drones. The plurality of drones moves such that the drones can arrive in initial locations at the same time. For example, on the assumption that the initial target locations of drones A, B, and C are P1, P2, and P3, the expected arrival time for drone A is T1 when drone A moves from the current location to P1, the expected arrival time for drone B is T2, and the expected arrival time for drone C is T3, then movements thereof may be controlled such that relationship of T1=T2=T3 is satisfied. Since the locations and conditions of the plurality of drones performing the task are different, the drones may be controlled so as to move minimizing energy consumption and start photographing, which is the next operation, on arrival.

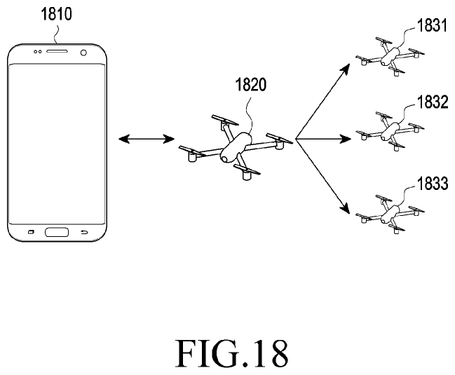

FIG. 18 is a conceptual view relating to a method for transmitting a signal from an electronic device to a plurality of drones according to various embodiments of the disclosure.

Techniques of controlling a plurality of drones with respect to a first drone are broadly twofold. “Formation flying” is one during which the relative positions of a plurality of second drones 1831, 1832, and 1833 are fixed with respect to a first drone 1820. Since the relative positions do not change, any drone among the plurality of second drones can be the first drone 1820. All the second drones 1820, 1831, 1832, and 1833 may at the same time receive a flight control signal transmitted by an electronic device 1810 as well. All the second drones 1820, 1831, 1832, and 1833 move on the basis of the control signal. The first drone 1820 delivers location information, etc. of the first drone 1820 to the plurality of second drones 1831, 1832, and 1833 at the same tune. If there is an error in position when the plurality of second drones 1831, 1832, and 1833 calculate the relative distances to the first drone 1820 and the relative positions from the current location, a control signal for compensation is individually delivered to motors installed in the second drones. If all the driving characteristics of the second drones are the same, when the same control signal is transmitted, the drones can move the same, with the current relative positions thereof maintained.

Path-following flying is one during which, when the first drone 1820 determines a route on receiving a control signal from the electronic device, the second drones 1831, 1832, and 1833 fly in order following the corresponding route. While the first drone 1820 moves from an initial location in compliance with a user's control command or a task, the first drone may deliver the current location thereof, time, etc. to the second drones 1831, 1832, and 1833. The second drones 1831, 1832, and 1833 may move in order along the route along which the first drone 1820 has moved. When the first drone 1820 is changed by a user's selection during formation flying, only the positions of the current first drone and former first drone can be swapped. When the first drone 1820 is automatically changed due to a problem having occurred therein, a second drone with second priority is succeeded as the first drone 1820 by receiving the role of the first drone and performs the role thereof. When the first drone 1820 is changed by the user during Path-following flying, the roles and positions of the former first drone and the current first drone may be swapped.

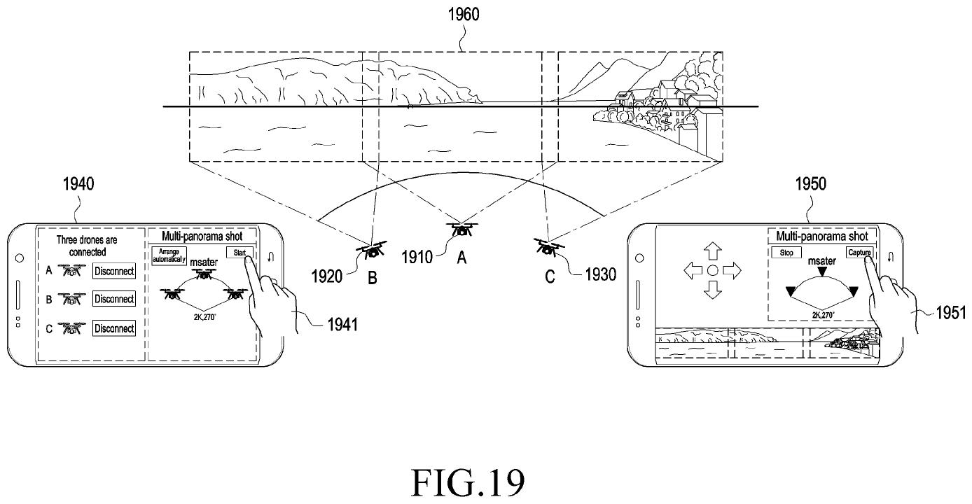

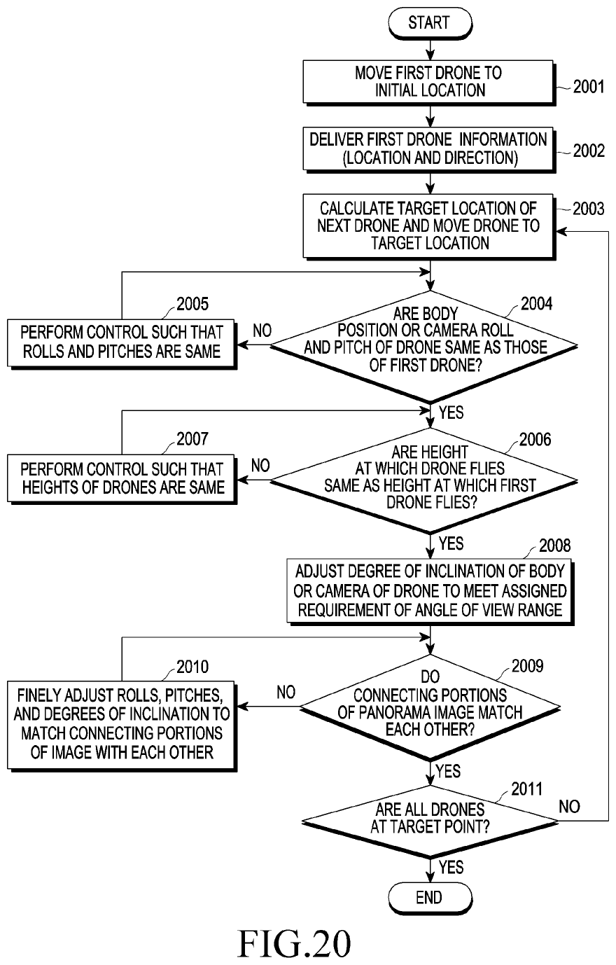

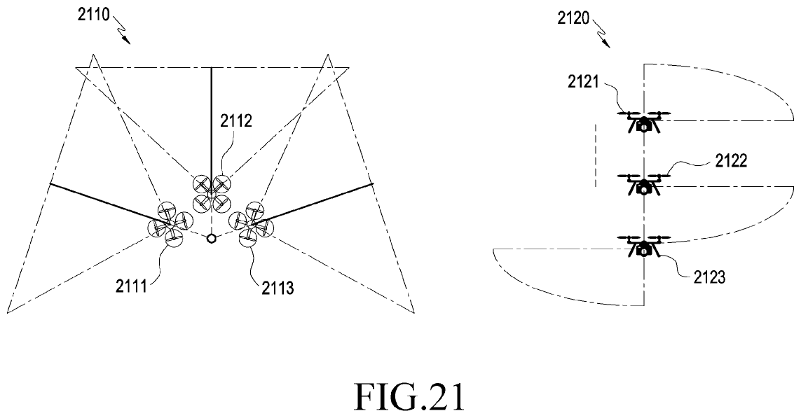

FIG. 19 is a conceptual view relating to a method for capturing a panorama image according to various embodiments of the disclosure. FIG. 20 is a flow chart relating to performing control for a method for capturing a panorama image according to various embodiments of the disclosure. FIG. 21 illustrates a method for arranging multiple drones when a panorama image is captured according to various embodiments of the disclosure.

At a command to capture a panorama content image, the first drone 1910 among drones 1910, 1920, and 1930 paired with an electronic device moves to an initial location in operation 2001. In operation 2002, the other drones 1920 and 1930 are informed of information on the location and direction of the first drone/a camera direction. The second drones 1920 and 1930, in operation 2003, may calculate the next locations, in hick the second drones can capture panorama content images, on the basis of the information received from the first drone and may move to the locations. Then, the electronic device 1940 may process information on the location and direction of the first drone and deliver information on locations to which the second drones are required to move. All the drones transmit camera images to the electronic device in real time in the initial locations thereof, respectively. Methods usablein order to capture a panorama image may include: a method for horizontally arranging a plurality of drones 2111, 2112, and 2113 as indicated by an arrow 2110 in FIG. 21, and a method of vertically arranging a plurality of drones 2111, 2112, and 2113 as indicated by an arrow 2120 in FIG. 21. When the arrangement is complete, flight may start when the electronic device receives a user input 1941. The horizontal arrangement is a technique of making all the center lines of cameras of the drones arranged on the same line, and the vertical arrangement is a technique of making the drones arranged in the same horizontal position while the drones fly differently in height. In order to reduce distortion in a process of compositing images captured by a plurality of drones, it is necessary for the plurality of drones to be arranged as close as possible. According to various embodiments of the disclosure, the plurality of drones may be positioned to have a minimum distance therebetween. Specifically, in operation 2004, whether cameras of the plurality of drones 2111, 2112, and 2113, or 2121, 2122, and 2123 have the same roll and pitch may be determined. When the rolls and pitches thereof are not the same, the electronic device 1950, in operation 2005, may control the plurality of drones such that the rolls and pitches of the plurality of drones are the same. In operation 2006, whether the respective bodies of the drones are at the same height may be determined. When the drones are not at the same height, the drone may be controlled so as to be at the same height in operation 2007. When the rolls, pitches, heights, etc. thereof have been adjusted, photographing using the drones may start when a user input 1951 is received. Operations 2006 and 2007 may not be included when the plurality of drones are vertically arranged. In operation 2008, the degrees of inclination of the bodies or cameras of the drones may be adjusted for an angle of view range assigned. In operation 2009, whether connecting portions of panorama images captured by the respective drones match each other may he determined after panorama photographing is complete. When the connecting portions do not match, the rolls, pitches, and inclination of the cameras may be adjusted in operation 2010 such that the connecting portions match each other. In operation 2011, whether all the drones 2111, 2112, and 2113, or 2121, 2122, and 2123 are at a target point, which is a task termination point, may be determined, and when it is determined that the drones are at the target point, the task may be terminated. The electronic device may receive images captured by the plurality of drones, generate a single panorama view from the images, and provide the same to the user. While checking the panorama view, the user may send a command to take a picture or capture a video and may individually or collectively control the location of the plurality of drones.

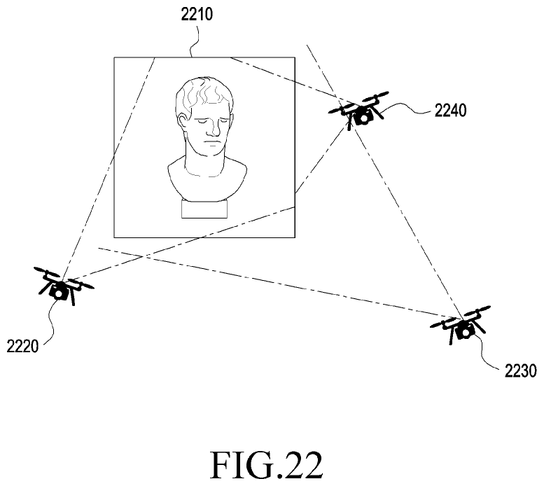

FIG. 22 is a conceptual view relating to three-dimensional photography according to various embodiments of the disclosure.

According to various embodiments, content may be generated by the use of a plurality of drones capturing images in multiple viewpoints. Compared with panorama photographing which is a method of capturing images in a number of directions from one point, multiple viewpoint photographing is a method of capturing images of one point in various directions and at various distances by a number of drones. According to a target 2210 and task, a first drone 2220 determines a distance and direction to the target and moves to a corresponding position. Second drones 2230 and 2240 may calculate position in which the second drones are to capture images of a photographic subject in different viewpoints, on the basis of information on the position and direction of the first drone 2220 and may move thereto and capture images.

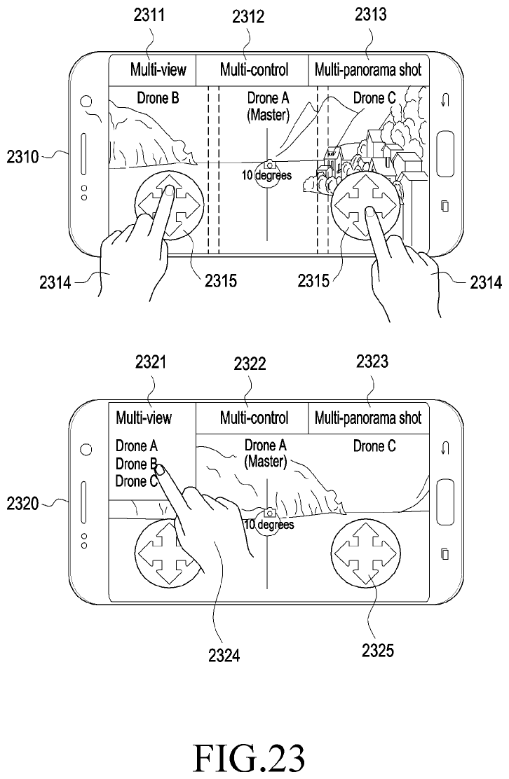

FIG. 23 is a conceptual view relating to a method for controlling a plurality of drones according to various embodiments of the disclosure.

A plurality of drones may be controlled at the same time by the use of a user input 2314 performed through a display of an electronic device 2310 and 2320. A user may select a drone to be used to see in the viewpoint thereof by using a first button 2311 and 2321, select a drone to control by using a second button 2312 and 2322, and select a task to assign by using a third button 2313 and 2323. On pressing a button 2311 reading “Multi-view” configured to control view finders, the user may select one of seeing in a collective multi-view and individually seeing in the viewpoint of each of drones A, B, and C (2324). When a user input 2314 performed through a control interface 2315 provided using a graphic user interface is received in a state where “Multi-control” 2312 and 2322 has been selected, all drones move accordingly, with the relative distances therebetween and positions thereof maintained with respect to a first drone. Then, camera tilting may be also controlled using a certain area of the screen.

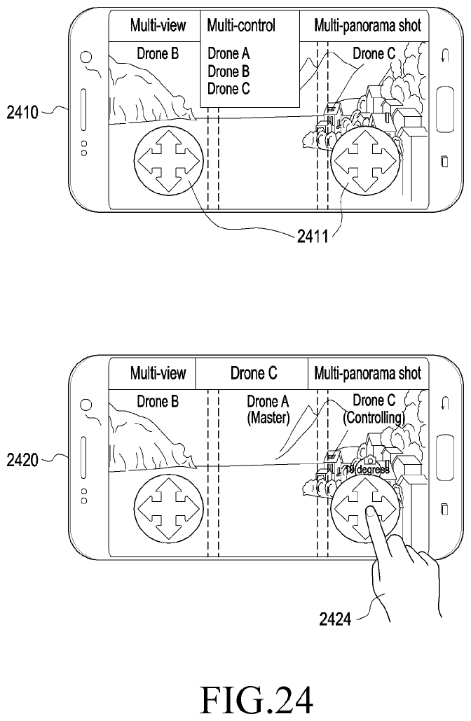

FIG. 24 is a view specifically illustrating a method of controlling each of the drones, subsequent to FIG. 23. In order to control the drones individually, the user can touch the “Multi-control” button and select a drone to control (one of drone A, drone B, or drone C), and when a user input is performed through a control interface 2411 of the electronic device 2410, the user input received through the control interface is delivered only to the selected drone so as to allow the individual control of the drone. When only drone C is controlled, an indication that only drone C is being controlled may be provided by the electronic device 2420. A control command by a user input 2424 may be delivered only to drone C so as to allow drone C alone to move.

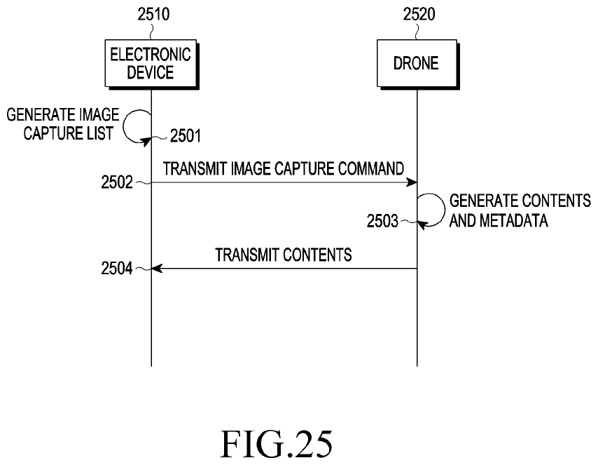

FIG. 25 is a flow chart of a method for transmitting content between an electronic device and a drone according to various embodiments of the disclosure.

As described above, an electronic device 2510 according to various embodiments may command a plurality of drones to capture images, as an example of tasks, and may determine targets and generate an image capture list before commanding a task (2510). When the electronic device has been paired with a plurality of drones 2520 to capture images, the electronic device transmits a signal for synchronization between the plurality of drones to the plurality of drones through a communication module. The drones 2520, having received the synchronization signal, calculate the deviations of master clocks of the drones 2520 according to the synchronization signal and record the calculated deviations. When all the drones 2520 are in a state of being able to receive time information of a GPS signal, a method for synchronizing the master clocks of the drones 2520 by using a GPS may be used as well. When the electronic device receives an image capture command from a user, the electronic device may generate an image capture list and deliver the image capture command to the plurality of drones simultaneously or sequentially (2502). The drones, having received the image capture command, generate content in compliance with the command, generate image capture-related metadata, and record related information such that distributed contents can be collected and composited later (2503). When content and metadata have been generated, the electronic device may receive contents from the respective drones through the communication module by using information of the image capture list. Since the electronic device 2510 can recognize the order of the contents taken by the respective drones, the electronic device may compose the contents into one item of content and store the same.

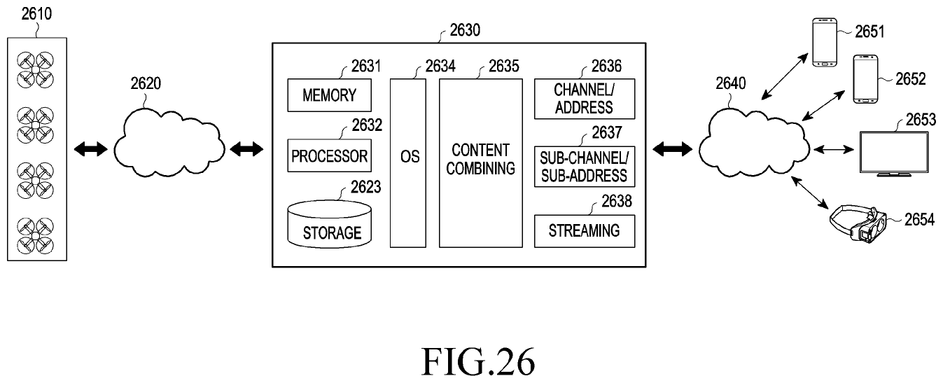

FIG. 26 is a conceptual view illustrating a method for providing content by an electronic device according to various embodiments of the disclosure.

A server may be provided which is used to reproduce content generated through a plurality of drones, for many users in various types of terminals. The server may be provided separately, or the electronic device may serve directly as the server. Content generated by a plurality of drones 2610 may be provided to a server 2630 through a network 2620 and provided to terminals 2641, 2642, 2643, and 2644 through a network 2640 through a channel/address 2636 or a sub-channel/sub-address 2637. The server 2630 may include a memory 2631, a processor 2632, and a storage 2633, and the processor 2632 may execute an Operating System (OS) 2634 of the server 2630, perform content combining 2635, or perform streaming 2638. The terminals 2651, 2652, 2653, and 2654 may reproduce contents to be watched, in a manner of communicating through a communication module of the server 2630 and transmit content in real time depending on the speed of a data communication network. On the contrary, a configuration in which, in reverse, the drones are controlled by the terminals 2651, 2652, 2653, and 2654 through the server 2630 may be possible. Since the properties of contents to be generated depend on the cameras installed in the drones, the contents may be provided according to the properties to each of the terminals or may be suitably changed to be compatible with each of the terminals and provided to the terminals. For example, when content generated by a drone in which a 360 degree camera is installed is modified to be compatible with Virtual Reality (VR) terminals and is transmitted, a user may watch a 360 degree image using a VR terminal 2644. Not only content generated by image capture but various information detected by sensors installed in the plurality of drones 2610 may also be provided to the terminals 2641, 2642, 2643, and 2644. Accordingly, the terminals 2641, 2642, 2643, and 2644 may receive and use the received various pieces of information and also control the plurality of drones 2610 on the basis of the received information.

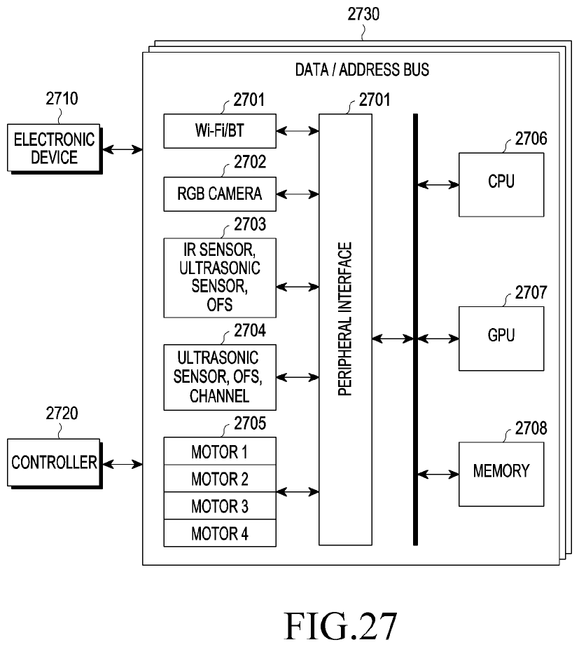

FIG. 27 is a conceptual view illustrating the inner structure of a drone according to various embodiments of the disclosure. The configuration in which the first drone and second drones are controlled by the electronic device has been described with reference to the drawings described above. However, the first drone and second drones are not required to be controlled by the electronic device. The first drone and second drones may perform various tasks by determining areas with respect to external drones and determining routes according to the areas, by themselves. A configuration will be hereinafter described in which a drone autonomously determines areas with respect to an external drone and performs pairing with an electronic device.

According to various embodiments of the disclosure, an electronic device 2710 and a plurality of drones 2730 are connected through wireless communication 2701 allowing communications using various communication methods, such as Wi-Fi and Bluetooth (BT), so as to transmit or receive necessary information bidirectionally. The drones may transmit captured image content to each other by using Wi-Fi or deliver drone operation information and a control signal to each other. Otherwise, by using BT, the drones may perform a multi-drone connection process and deliver the control signal as well. The drones may also effectively deliver the same information to a number of devices by using a multicasting method, and may replace the electronic device 2710 by using a separate controller 2720 or may be used together. A drone 2730 may include a camera configured to capture an image, and an IR sensor, ultrasonic sensor, Optical Flow Sensor (OFS), (IPS), barometer, compass, 9-axis sensor (2703), etc., which are configured to detect an Obstacle and control the posture and position thereof. The drone also includes motors configured to drive the drone, and a storage configured to store content or necessary data. The drone 2730 may include a CPU 2706, GPU 2707, and memory 2708, which process and store an image and information input from the RGB camera 2702 or the sensors 2703. The hardware and peripheral devices mentioned above may be connected to the processor 2706, GPU 2707, and memory 2708 by an interface and data bus/address bus (not illustrated) to transmit and receive information.

A first distance may be determined on the basis of information on at least one of the size of the first drone, the speed of the first drone, an external force applied to the first drone, and the capability to compensate for an error in the position of the first drone. According to another embodiment of the disclosure, the processor 2706 may receive an initial location and a route of the external drone through the communication module and determine a route for the drone such that the drone is the first distance or more away from the external drone.

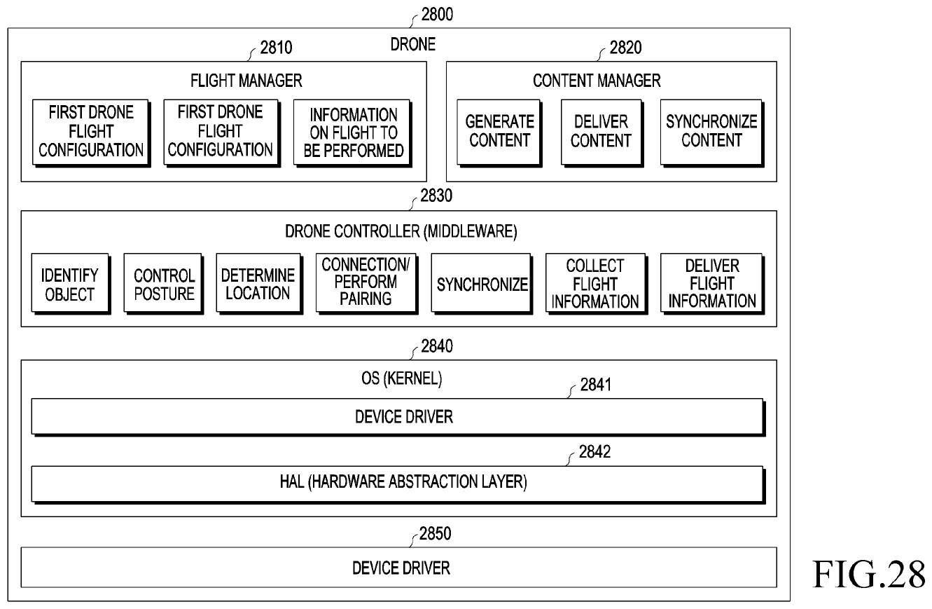

In a drone according to yet another embodiment, the processor 2706 may receive, from an external electronic device, a pairing request through the communication module and perform pairing with the external electronic device in response to the received pairing request. That is, the electronic device 2710 is used to perform pairing with the drone, and the drone is not required to be controlled by the external electronic device 2710. On the basis of a task received from the electronic device 2710 paired therewith, multiple drones fundamentally can perform the task by themselves, although the electronic device 2710 can arrange the multiple drones, receive a task delivered from a user, deliver a state of the multiple drones to the user, or directly intervene in the task as needed. All matters, related to the determination of areas and a route for a drone, the control of the drone, etc. described in the sections for FIGS. 4 to 26, may be also applied in the same manner to the drones illustrated in FIGS. 27 and 28. In a iron-transitory computer-readable recording medium in which a program to be executed in a computer is recorded, according to various embodiments of the disclosure, the program, when executed by a processor, may command the processor to perform the operations.

FIG. 28 is another conceptual view illustrating the inner structure of a drone according to various embodiments of the disclosure.

A drone controller 2830 may identify a target object or determine the location thereof, individually control the postures of a number of drones on the basis of information on the positions of the drones, and manage and analyze information for synchronization. The drone controller may also perform connection and pairing processes and store information necessary thereof. The drone controller may also collect flight information relating to flying, such as a location, an altitude, and a direction, and may deliver the flight information to another drone. A content manager 2820 may receive, from a user, a command to generate content according to flight to be performed and analyze the received command and may generate content accordingly. The generated content may be delivered to the electronic device or the controller. Content synchronization information used for compositing, into one item of content, distributed contents stored between a number of drones may be stored as well. The flight manager 2810 analyzes information on the flight to be performed that is received from the user. Accordingly, when the role of the first drone is given, information on a first drone flight configuration is processed, and when the role of the second drone is given, information on a second flight configuration is processed. The others, that is, an OS (Kernel) 2840, a device driver 2841, and a HAL 2842, may be used to arrange a software environment to allow the software mentioned above to run in module hardware 2850.

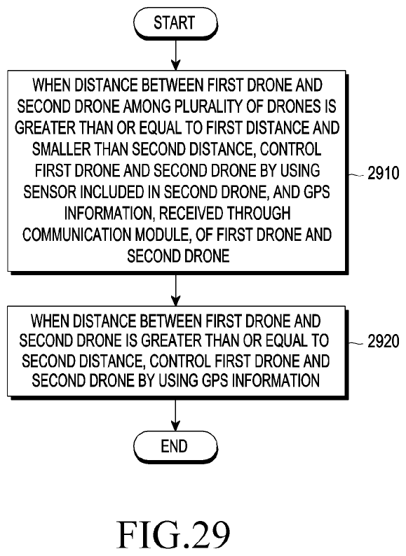

FIG. 29 is a flow chart of an operation of controlling a drone according to various embodiments of the disclosure.

In a non-transitory computer-readable recording medium in which a program to be executed in a computer is recorded, according to various embodiments of the disclosure, the program, when executed by a processor 120, may command in operation 2910 that, when the distance between a first drone and a second drone among a plurality of drones is greater than or equal to a first distance and is smaller than a second distance, the processor 120 controls the first drone and the second drone by using a sensor included in the second drone and GPS information received through the communication module of the first drone and the second drone. In operation 2920, the program may command that, when the distance between the first drone and the second drone is greater than or equal to the second distance, the processor controls the first drone and the second drone by using the GPS information. Details of a recording medium configured to control the plurality of drones according to various embodiments of the disclosure are the same as those of the electronic device described above. Therefore, the details will be omitted.

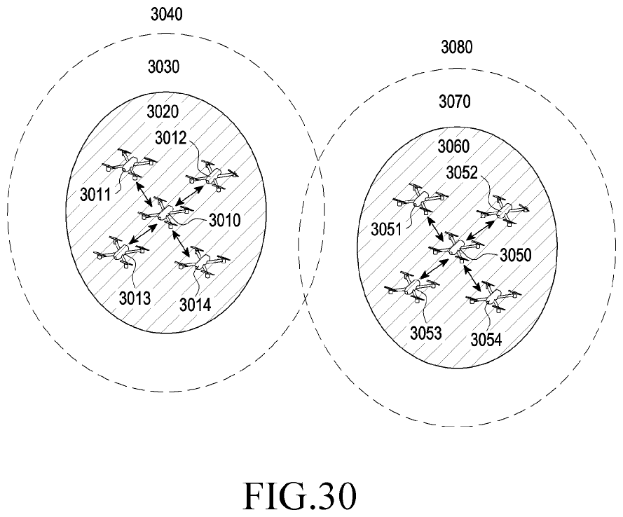

FIG. 30 is a conceptual view relating to determining areas between sets of drones according to various embodiments of the disclosure.

What has been heretofore described in the various embodiments is that areas and a route for each drone are determined by the electronic device. Hereinafter disclosed will be embodiments in which a plurality of drones is configured as a drone set, and determination of areas for each drone set and collision avoidance between drone sets are performed. Each of the drone sets may thereby prevent collision between the sets during tasks thereof.

In an electronic device according to various embodiments, a memory of the electronic device may store information on a touch screen, a plurality of first drones 3010, 3011, 3012, 3013, and 3014, and a plurality of second drones 3050, 3051, 3052, 3053, and 3054, which are paired with the electronic device, and information on a first task to be performed by the plurality of first drones 3010, 3011, 3012, 3013, and 3014, and a second task to be performed by the plurality of second drones 3050, 3051, 3052, 3053, and 3054.

According to various embodiments, a processor 120 of the electronic device may determine a route for the plurality of first drones 3010, 3011, 3012, 3013, and 3014 on the basis of at least one of the information relating to the plurality of first drones 3010, 3011, 3012, 3013, and 3014 and the information relating to the first task to be performed by the plurality of first drones 3010, 3011, 3012, 3013, and 3014, may determine a route for the plurality of second drones 3050, 3051, 3052, 3053, and 3054 paired with the electronic device such that the plurality of second drones 3050, 3051, 3052, 3053, and 3054 is positioned in a first area where the distance from the route for the plurality of first drones 3010, 3011, 3012, 3013, and 3014 is greater than or equal to a first distance, to perform the second task, and may perform control such that the plurality of second drones 3050, 3051, 3052, 3053, and 3054 perform the second task in the route for the second drones 3050, 3051, 3052, 3053, and 3054. That is, the processor 120 may determine respective routes for the plurality of first drones 3010, 3011, 3012, 3013, and 3014 and the plurality of second drones 3050, 3051, 3052, 3053, and 3054, and during the determination of the route for the plurality of second drones 3050, 3051, 3052, 3053, and 3054, the processor may make determination such that the route does not pass through the collision area 3020 for the plurality of first drones. As described above, the first area 3030 and 3040 and the second area 3030 may be determined on the basis of the first distance and second distance based on the information on the plurality of first drones 3010, 3011, 3012, 3013, and 3014 and the information relating to the task. In the same manner, for the plurality of second drones 3050, 3051, 3052, 3053, and 3054, the collision area 3060, first area 3070 and 3080, and second area 3070 may be determined. In relation to the processor 120 of the electronic device according to various embodiments, when the distance between the plurality of first drones and the plurality of second drones is greater than or equal to the first distance and is smaller than the second distance, the processor may control the plurality of first drones and the plurality of second drones by using a sensor included in the second drones and GPS information, received through the communication module, of the plurality of first drones and the plurality of second drones, but when the distance between the plurality of first drones and the plurality of second drones is greater than or equal to the second distance, the processor may control the plurality of first drones and the plurality of second drones by using the GPS information.

Although the areas may be determined in various ways, the processors 120 of the plurality of first drones, particularly, may determine collision areas for the respective first drones and then determine a three-dimensional area into which the collision areas of the respective first drones are merged, as a collision area for all the plurality of first drones. According to various embodiments, the electronic device may include a communication module configured to deliver the signal to the plurality of first drones 3010, 3011, 3012, 3013, and 3014 and the plurality of second drones or receive a GPS signal from a satellite. The information described above, such as the first distance, second distance, and current location of a plurality of first drones, which have a representative drone representing the plurality of first drones, may be transmitted to a drone representing a plurality of second drones through a separate network channel (Wi-Fi, 5G, etc. at a different frequency). The drone representing the second drones may transmit the received information to the other drones belonging to the group. All the configurations relating to the electronic device described before in the sections for FIGS. 1 to 26 can be applied to the above electronic device in the same manner. Therefore, the details will be omitted.

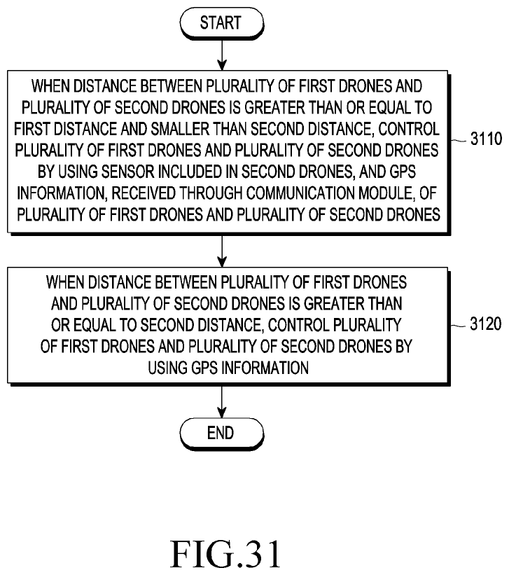

FIG. 31 is a flow chart of an operation of determining areas between sets of drones according to various embodiments of the disclosure.

A method for controlling a plurality of drones according to various embodiments, in operation 3110, may store information on a plurality of first drones and a plurality of second drones, paired with the electronic device, and information on a first task to be performed by the plurality of first drones and a second task to be performed by the plurality of second drones. In operation 3120, the method may determine a route for the plurality of drones on the basis of at least one of information related to the plurality of first drones and information related to the first task to be performed by the plurality of first drones, and may determine a route for the plurality of second drones such that the plurality of second drones paired with the electronic device is positioned in a first area where the distance from the route for the plurality of first drones is greater than or equal to a first threshold value, to perform the second task. The method may generate a signal for control such that the plurality of second drones performs the second task in the route for the second drones and may transmit the signal to the plurality of first drones and the plurality of second drones.

In various embodiments, the first area includes a second area where a distance from the plurality of first drones is greater than or equal to the first threshold value and is smaller than or equal to a second threshold value. When the second drones are located in a third area, an operation of generating a signal for performing control such that a second drone measures the distance from a first drone by using at least one of an RGB sensor, an ultrasonic sensor, an IR sensor, and a BT signal may be performed. All the matters relating to the electronic device described in the section for FIG. 28 can be applied in the same manner to the above method for controlling a plurality of drones. Therefore, the details will be omitted.

In an unmanned aerial vehicle system according to various embodiments of the disclosure, the system may include a first unmanned aerial vehicle having a first status and a first set of capabilities. The system may include a second unmanned aerial vehicle having a second status and a second set of capabilities, and the first unmanned aerial vehicle. The first status and second status may relate to the above-described environmental information and variable information of the first unmanned aerial vehicle and second unmanned aerial vehicle, such as a battery charge level, a GPS connection state, Wi-Fi/BT bandwidth, signal strength, etc. The first capabilities and second capabilities may relate to the above-described fixed information on motors, processing performance, camera resolution, camera angle, the number of sensors, etc.

The system may include a controller device wirelessly connectible to the second unmanned aerial vehicle, and the controller device may include a user interface, at least one wireless communication circuit, a processor electrically connected to the user interface and communication circuit, and a memory electrically connected to the processor. The memory may cause, at run-time, the processor to establish a first communication channel with the first unmanned aerial vehicle by using the communication circuit, and establish a second communication channel with the second unmanned aerial vehicle by using the communication circuit. The operation of establishing the first communication channel and the second with the first unmanned aerial vehicle and the second unmanned aerial vehicle may be performed in the same manner as the operation described above of pairing an electronic device with a drone.

The processor may receive first data relating to at least part of the first status and/or first set of capabilities through the first communication channel, and receive second data relating to at least part of the second status and/or second set of capabilities through the second communication channel. On receiving the statuses and capabilities of the first unmanned aerial vehicle and second unmanned aerial vehicle, the processor may receive an input related to flight routes for the first unmanned aerial vehicle and second unmanned aerial vehicle from a user through the user interface. The processor may determine a first flight route for the first aerial vehicle and a second flight route, different from the first flight route, for the second aerial vehicle on the basis of the input, the first data, and the second data. When information on the determined routes is determined and generated, information relating to the first flight route may be transmitted through the first channel, and information relating to the second flight route may be transmitted through the second channel.

The processor according to various embodiments of the disclosure may perform control so as to keep the first flight route and the second flight route a first distance or more away from each other at all time.

In relation to an electronic device controlling an unmanned aerial vehicle according to various embodiments of the disclosure, the electronic device may include a user interface, at least one wireless communication circuit, a processor electrically connected to the user interface and communication circuit, and a memory electrically connected to the processor, wherein the memory causes, at run-time, the processor to: establish a first communication channel with a first unmanned aerial vehicle having a first status and a first set of capabilities by using the communication circuit; establish a second communication channel with a second unmanned aerial vehicle having a second status and a second set of capabilities by using the communication circuit; receive first data relating to at least part of the first status and/or first set of capabilities through the first communication channel; receive second data relating to at least part of the second status and/or second set of capabilities through the second communication channel; receive an input related to flight routes for the first unmanned aerial vehicle and second unmanned aerial vehicle from a user through the user interface; determine a first flight route for the first aerial vehicle and a second flight route, different from the first flight route, for the second aerial vehicle on the basis of the input, the first data, and the second data; transmit information relating to the first flight route through the first channel; and transmit information relating to the second flight route through the second channel.

In relation to an electronic device controlling an unmanned aerial vehicle according to various embodiments of the disclosure, the electronic device may include a user interface, at least one wireless communication circuit, a processor electrically connected to the user interface and communication circuit, and a memory electrically connected to the processor, wherein the memory stores instructions causing, at run-time, the processor to: establish a first communication channel with a first unmanned aerial vehicle having a first status and a first set of capabilities by using the communication circuit; establish a second communication channel with a second unmanned aerial vehicle having a second status and a second set of capabilities by using the communication circuit; receive first data relating to at least part of the first status and/or first set of capabilities through the first communication channel; receive second data relating to at least part of the second status and/or second set of capabilities through the second communication channel; determine a first flight route for the first aerial vehicle on the basis of the first data and the second data; determine a second flight route for the second aerial vehicle on the basis of at least part of the first flight route, the first data, and/or the second data; transmit information relating to the first flight route through the first channel; and transmit information relating to the second flight route through the second channel. The user interface may denote various hardware devices that can detect user inputs. The user interface may be provided using a separate input device, and may be an input device installed in the electronic device, as a touch screen.

The electronic device according to various embodiments of the disclosure may include a display, and the processor may display, through the display, the locations of the first unmanned aerial vehicle and the second unmanned aerial vehicle by using the user interface. The processor may detect an input for changing the location of the first unmanned aerial vehicle or the second unmanned aerial vehicle by using the user interface and may transmit location change information to the first unmanned aerial vehicle or the second unmanned aerial vehicle according to the detected input. The processor may determine targets of the first unmanned aerial vehicle and the second unmanned aerial vehicle and display, through the display, the changed distances between the first unmanned aerial vehicle and the second unmanned aerial vehicle due to the change in location of the first unmanned aerial vehicle and the second unmanned aerial vehicle, and the angles formed by the target, the first unmanned aerial vehicle, and the second unmanned aerial vehicle. All the details applied to the unmanned aerial vehicles are the same as the details related to the drones described in the sections for the preceding drawings, and the details related to the user interface can be also applied in the same manner as those of the graphic user interface specifically described in the sections for the preceding drawings. Therefore, detailed descriptions will be omitted.

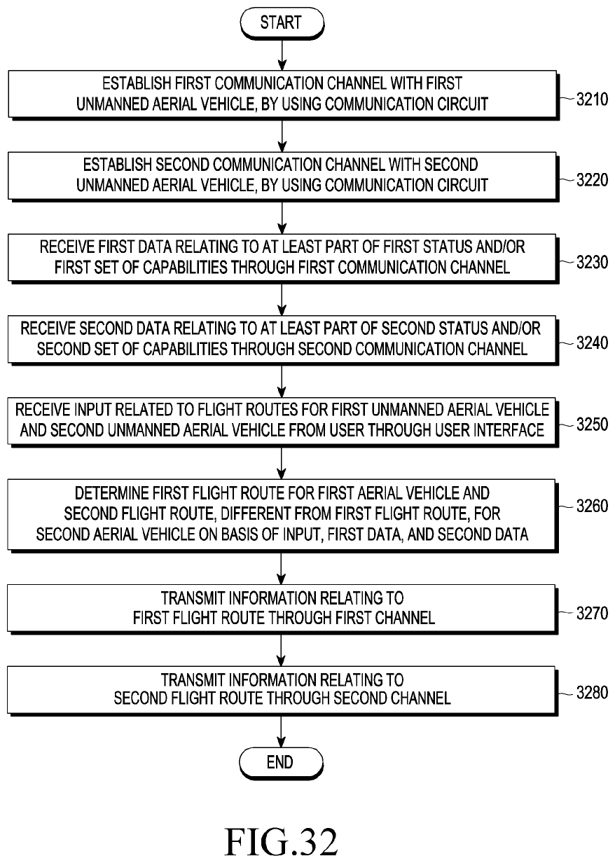

FIG. 32 is a flow chart of a method for controlling a plurality of unmanned aerial vehicles according to various embodiments of the disclosure.

In operation 3210, by using a communication circuit, a first communication channel with the first unmanned aerial vehicle may be established. In operation 3220, by using the communication circuit, a second communication channel with the second unmanned aerial vehicle may be established. In operation 3230, through the first communication channel, first data relating to at least part of the first status and/or first set of capabilities may be received. In operation 3240, through the second communication channel, second data relating to at least part of the second status and/or second set of capabilities may be received. In operation 3250, through a user interface, an input related to flight routes for the first unmanned aerial vehicle and second unmanned aerial vehicle from a user may be received. In operation 3260, a first flight route for the first aerial vehicle and a second flight route, different from the first flight route, for the second aerial vehicle may be determined on the basis of the input, the first data, and the second data. In operation 3270, information relating to the first flight route may be transmitted through the first channel. In operation 3280, information relating to the second flight route may be transmitted through the second channel.

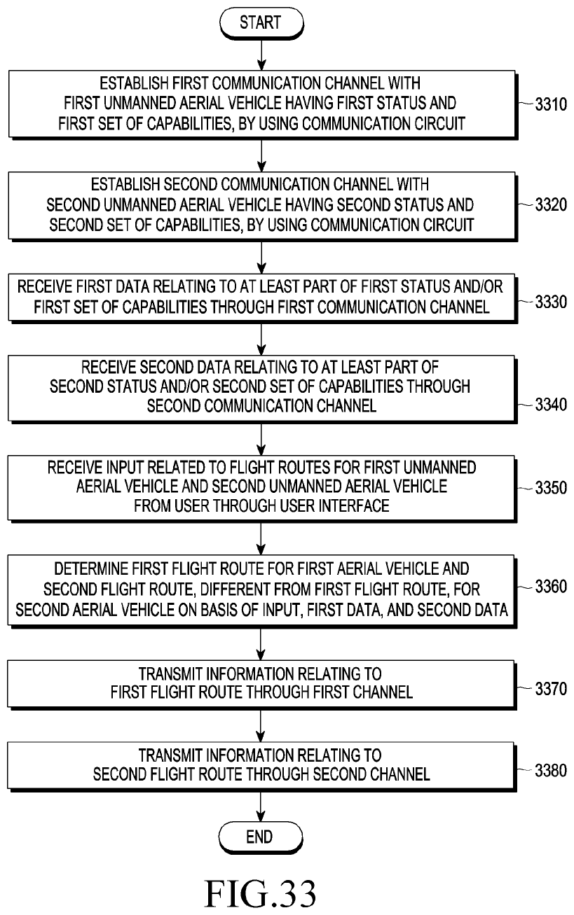

FIG. 33 is a flow chart of a method for controlling a plurality of unmanned aerial vehicles according to various embodiments of the disclosure.

In operation 3310, a first communication channel with a first unmanned aerial vehicle having a first status and a first set of capabilities may be established using a communication circuit. In operation 3320, a second communication channel with a second unmanned aerial vehicle having a second status and a second set of capabilities may be established using the communication circuit. In operation 3330, first data relating to at least part of the first status and/or first set of capabilities may be received through the first communication channel. In operation 3340, second data relating to at least part of the second status and/or second set of capabilities may be received through the second communication channel. In operation 3350, an input elated to flight routes for the first unmanned aerial vehicle and second unmanned aerial vehicle may be received from a user through the user interface. In operation 3360, a first flight route for the first aerial vehicle and a second flight route, different from the first flight route, for the second aerial vehicle may be determined on the basis of the input, the first data, and the second data. In operation 3370, information relating to the first flight route may be transmitted through the first channel. In operation 3380, information relating to the second flight route may be transmitted through the second channel.

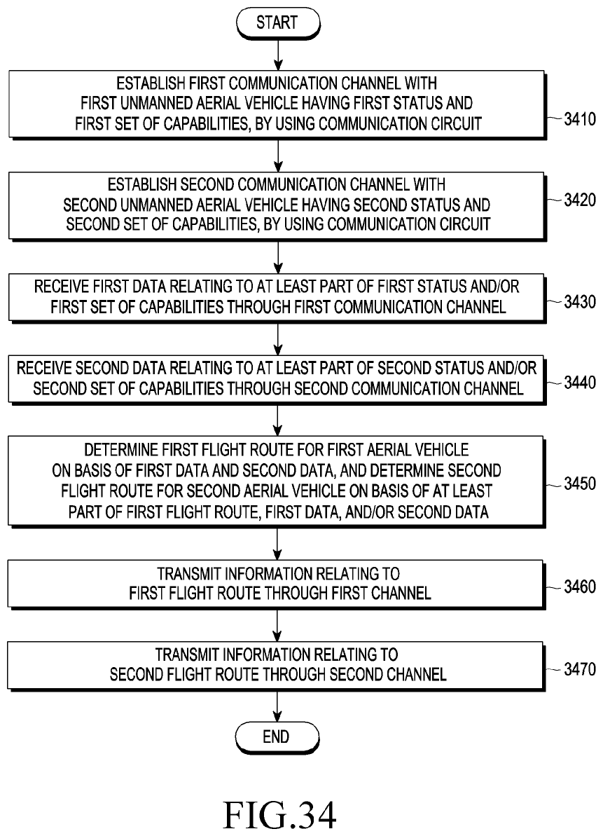

FIG. 34 is a flow chart of a method for controlling a plurality of unmanned aerial vehicles according to various embodiments of the disclosure.

In operation 3410, a first communication channel with a first unmanned aerial vehicle having a first status and a first set of capabilities may be established using a communication circuit. In operation 3420, a second communication channel with a second unmanned aerial vehicle having a second status and a second set of capabilities may be established using the communication circuit. In operation 3430, through the first communication channel, first data relating to at least part of the first status and/or first set of capabilities may be received. In operation 3440 through the second communication channel, second data relating to at least part of the second status and/or second set of capabilities may be received. In operation 3450, a first flight route for the first aerial vehicle may be determined on the basis of the first data and the second data. A second flight route for the second aerial vehicle may be determined on the basis of at least part of the first flight route, the first data, and/or the second data. In operation 3460, information relating to the first flight route may be transmitted through the first channel. Information relating to the second flight route may be transmitted through the second channel. Details relating to performing the operations described in the sections for FIGS. 32 to 34 are the same as the details described in the sections for FIGS. 1 to 31. Therefore, specific descriptions will be omitted.

A non-transitory computer-readable recording medium in hick a program to be executed in a computer is recorded may be provided. The program includes an executable command which, when executed by a processor 120, causes the processor 120 to perform the operations of: when the distance between a first drone and a second drone among a plurality of drones is greater than or equal to a first distance and is smaller than a second distance, controlling the first drone and the second drone by using a sensor included in the second drone, and GPS information, received through the communication module, of the first drone and the second drone; and when the distance between the first drone and the second drone is greater than or equal to the second distance, controlling the first drone and the second drone by using the GPS information.

According to various embodiments, the operation of, when the distance between a first drone and a second drone among a plurality of drones is greater than or equal to a first distance and is smaller than a second distance, controlling the first drone and the second drone by using a sensor included in the second drone, and GPS information, received through the communication module, of the first drone and the second drone, may include an operation of selecting the first drone on the basis of at least part of information on the first drone and the second drone and information on the task, and performing control such that the second drone is positioned the first distance or more away from the selected first drone.

Various embodiments may provide a computer-readable recording medium which provides an operation of, when the distance between a first drone and a second drone is greater than or equal to the second distance, controlling the first drone and the second drone by using the GPS information, wherein the operation includes an operation of selecting the first drone on the basis of at least part of information on the first drone and the second drone and information on the task, and performing control such that the second drone is positioned the first distance or more away from the selected first drone.

In various embodiments, an operation of determining the first distance on the basis of information related to at least one of the size of the first drone, the speed of the first drone, an external force applied to the first drone, and the capability to compensate for an error in the position of the first drone may be further included.

In various embodiments, the processor 120 may further perform an operation of transmitting a pairing request to at least one drone among the first drone and the second drone, and performing pairing with the at least one drone on the basis of an acceptance response from the at least one drone to the pairing request.

In various embodiments, the processor 120 may further perform an operation of determining an initial location of the first drone, and determining a route for the second drone such that the second drone is at a distance of a first threshold value or more from the first drone which is in the initial location, and an operation of transmitting, by the communication module, the route for the second drone and information related to the initial location of the first drone to at least one of the first drone and second drone.

In various embodiments, a computer-readable recording medium causes the processor 120 to perform: an operation of displaying position information of the first drone and the second drone through the touch screen; and an operation of receiving position control information of the plurality of drones input from a user through the touch screen, and controlling the at least one drone according to the input information. In various embodiments, the processor 120 may perform an operation of determining weight values according to pieces of information on the first drone, and establishing higher priority when the sum of the weight values is greater.

Various embodiments disclosed herein are provided merely to easily describe technical details of the disclosure and to help the understanding of the disclosure, and are not intended to limit the scope of the disclosure. Therefore, it should be construed that all modifications and changes or modified and changed forms based on the technical idea of the disclosure fall within the scope of the disclosure.

1. A drone comprising:
a communication module configured to communicate wirelessly with an external drone; and
a processor configured to control a position of the drone by using a sensor included in the drone and GPS information, received through the communication module, of the external drone, when a distance from the external drone is greater than or equal to a first distance and is smaller than a second distance, and control the position of the drone by using the GPS information, when the distance from the external drone is greater than or equal to the second distance.

2. The drone of claim 1, wherein when the drone is positioned in an area where a distance from the external drone is greater than the first distance and smaller than the second distance, the processor performs control such that the drone measures distance from the external drone by using at least one of an RGB sensor, an ultrasonic sensor, an IR sensor, and a BT signal, which are included in the drone.

3. The drone of claim 1, wherein the processor receives a pairing request from an electronic device, transmits a response to the pairing request, and transmits information on the drone to the electronic device when the drone has been paired with the electronic device.

4. The drone of claim 1, wherein the processor determines the first distance on a basis of information related to at least one of a size of the first drone, a speed of the first drone, an external force applied to the first drone, and a capability to compensate for a positional error of the first drone.

5. The drone of claim 1, wherein the processor receives an initial location and a route of the external drone through the communication module and determines a route for the drone such that the drone is the first distance or more away from the external drone.

6. The drone of claim 1, wherein the processor receives a pairing request through the communication module from an external electronic device and performs pairing with the external electronic device in response to the received pairing request.

7. An electronic device comprising:
a communication module; and
a processor configured to control a first drone and a second drone among multiple drones by using a sensor included in the second drone and GPS information, received through the communication module, of the first drone and the second drone, in response to a distance between the first drone and the second drone being greater than or equal to a first distance and is smaller than a second distance, and control the first drone and the second drone by using the GPS information, in response to the distance between the first drone and the second drone being greater than or equal to the second distance.

8. The electronic device of claim 7, wherein the processor selects the first drone on a basis of at least part of information on the first drone and the second drone and information on a task and performs control such that the second drone is positioned the first distance or more away from the selected first drone.

9. The electronic device of claim 7, wherein when the second drone is positioned in an area where the distance is greater than the first distance and smaller than the second distance, the processor performs control such that the second drone measures distance from the first drone by using at least one of an RGB sensor, an ultrasonic sensor, an IR sensor, and a BT signal, which are included in the second drone.

10. The electronic device of claim 7, wherein the processor determines the first distance on a basis of information related to at least one of a size of the first drone, a speed of the first drone, an external force applied to the first drone, and a capability to compensate for a positional error of the first drone.

11. The electronic device of claim 7, wherein the processor transmits a pairing request to at least one drone among the first drone and the second drone and performs pairing with the at least one drone on a basis of an acceptance response from the at least one drone to the pairing request.

12. The electronic device of claim 7, wherein the processor determines an initial location of the first drone and determines a route for the second drone such that the second drone is the first distance or more away from the first drone which is in the initial location, and the communication module transmits information related to the initial location of the first drone, and the route for the second drone to at least one of the first drone and the second drone.

13. The electronic device of claim 7, wherein the electronic device comprises a touch screen, and the processor displays location information of the first drone and the second drone through the touch screen, receives location control information for the multiple drones input by a user through the touch screen, and controls at least one of the first drone and the second drone according to the input information.

14. The electronic device of claim 7, wherein the processor determines weight values according to pieces of information on the first drone, respectively, and establishes higher priority when a sum of the weight values is greater.

15. A non-transitory computer-readable recording medium in which a program to be executed in a computer is recorded, wherein the program comprises an executable command which, when executed by the processor, causes the processor to perform the operations of: controlling a first drone and a second drone among multiple drones by using a sensor included in the second drone and GPS information, received through a communication module, of the first drone and the second drone, when a distance between the first drone and the second drone is greater than or equal to a first distance and is smaller than a second distance; and controlling the first drone and the second drone by using the GPS information, when the distance between the first drone and the second drone is greater than or equal to the second distance.
